(19) United States
(12) Patent Application Publication
(10) Pub. No.: US 2013/0054402 A1
(43) Pub. Date: Feb. 28, 2013

(54) SYSTEM FOR DIGITAL COMMERCE AND METHOD OF SECURE, AUTOMATED CREDITING OF PUBLISHERS, EDITORS, CONTENT PROVIDERS, AND AFFILIATES

(71) Applicants: Michael ASHERMAN, Cambridge, MA (US); Steven ASHERMAN, New York, NY (US); Arun KUMAR, Bangalore (IN); Narayan SINGHAL, Glen Ridge, NJ (US); Andrew PUGLIESE, Glen Ridge, NJ (US)

(72) Inventors: Michael ASHERMAN, Cambridge, MA (US); Steven ASHERMAN, New York, NY (US); Arun KUMAR, Bangalore (IN); Narayan SINGHAL, Glen Ridge, NJ (US); Andrew PUGLIESE, Glen Ridge, NJ (US)

(73) Assignee: CONTENT GALAXY INC., New York, NY (US)

(21) Appl. No.: 13/594,074

(22) Filed: Aug. 24, 2012

Related U.S. Application Data
(63) Continuation-in-part of application No. 12/704,074, filed on Feb. 11, 2010.
(60) Provisional application No. 61/207,346, filed on Feb. 11, 2009.
(60) Provisional application No. 61/527,191, filed on Aug. 25, 2011.

(51) Int. Cl. G06Q 30/00

(52) U.S. Cl. 705/26.2

(57) ABSTRACT

The disclosure relates to the Content Marketplace Platform (CMP), a system and method of distributing digital content to authenticated users, such as on-line subscribers, wherein all interested parties, such as, but not limited to, publishers, editors, content providers, affiliates, payment processors, and service providers, are credited automatically for their contributions in such as manner as to be perceived as being fair, transparent, and resistant to abuse. The system and method may include a digital rights management system, but this is not required. The system supports a unique method of accounting that provides appropriate incentives to editors and affiliates, as well as publishers, with facilities for specifying a set of flexible parameters that enable automated payment, accounting, reporting, and administrative functions needed to support secure, subscription-based on-line publications.

This application is a continuation-in-part of application Ser. No. 12/704,074, filed on Feb. 11, 2010 which, in turn, claims priority under 35 U.S.C. §119(e) of U.S. provisional application Ser. No. 61/207,346 filed Feb. 11, 2009. The present application further claims priority under 35 U.S.C. §119(e) of U.S. provisional application Ser. No. 61/527,191, filed Aug. 25, 2011. The disclosure of all of these applications is hereby incorporated by reference in their entirety.

### BACKGROUND OF THE DISCLOSURE

1. Field of the Disclosure

The present disclosure, describing the Content Marketplace Platform (CMP), relates generally to methods and systems for digital commerce. More particularly, the present disclosure relates to subscription services in which subscribers pay for time-based (e.g. annual, monthly, or daily) subscriptions to a collection of content from a plurality of copyright holders, where subscribers are not charged for individual items of content, but content providers and other participants in the service automatically receive compensation based on subscriber activity. Participants who may receive automatic compensation include the provider of the service, tax authorities, payment processors, affiliates, independent publishers, editors, and content providers (authors, artists, and other copyright holders).

2. Description of the Prior Art

The Internet has profoundly changed commerce in information and amplified its importance. Prior to the Internet, information commerce was largely confined to physical media: books, magazines, photographs, audio and video recordings, etc. The Internet gave birth to commerce in pure digital information, dramatically reducing the cost of reproducing and distributing content to a vast audience. While this transformation has created many new opportunities for profit, it also presents a number of as-yet unresolved problems, which the present disclosure aims to address.

Any successful system of commerce needs to be perceived as fair and trustworthy by consumers, producers, and all other participants in the value chain. With the emergence of pure digital commerce, a basic problem that arises is the difficulty of establishing a fair price for content, since traditional methods of cost-based valuation generally do not apply. A significant further obstacle to Internet-based commerce is the climate of distrust that has become increasingly pervasive, fostered by anonymity, complexity, and continual technological change. These problems must be overcome for Internet-based digital commerce to attain its full potential.

Broadly speaking, there are three types of digital commerce currently in use. The first and most widely used approach is that of free, advertising-sponsored content. The second approach is one of a la carte purchasing of individual pieces of content, e.g. Apple's iTunes Store, analogous to a store dealing in tangible goods. Finally, there are paid subscription systems, such as Netflix, where items of content are not purchased individually, but the consumer is granted access to an entire collection of content for some period of time. Free, advertising-based systems for monetizing digital content tend to be heavily dependent on advertising services provided by a few major companies, most notably Google. Google's AdSense technology, for example, enables independent web sites to generate advertising income simply by incorporating certain pieces of proprietary AdSense code into their web pages. This can be lucrative for purveyors of content with broad enough appeal to generate very high volumes of traffic. However, such advertising usually does not yield substantial revenues for narrowly targeted pages, even if the content is of high quality. The reason for this is that each ad, on average, must be viewed hundreds of times to generate a single “click-thru” event, which may produce only pennies of advertising income to the page's owner. Thus for many, if not most items of valuable digital content, it would take an inordinately long time for advertising revenues to recoup the author's investment of time and expense to produce the content.

A la carte purchasing is the traditional way of selling merchandise in general, and this approach has been applied successfully to pure digital commerce with the help of “electronic shopping cart” facilities and online “e-stores” like those belonging to Apple and Amazon. When there exists an equivalent physical product, such as a printed book, CD, or DVD, it establishes a competitive price for its alternative, purely digital counterpart. But for most new digital content, with no established physical equivalent, it is hard to justify any particular choice of price to consumers. Another complication is that people are accustomed to consuming content on the Internet in a casual, incremental way, so it becomes necessary to account for very small units of consumption, smaller than what would be practical to bill as conventional financial transactions, i.e. separate credit card charges. Some systems use a micro-payment mechanism, but this adds much complexity and does not address the basic difficulty, for most kinds of valuable digital content, of determining how to price the material profitably, while making a compelling offer to consumers.

Subscription-based systems have long been used for selling printed publications, and this approach has grown increasingly popular for digital commerce, as publishers (e.g. The Wall St. Journal and NY Times) have found it increasingly difficult to sustain a profitable online business on advertising revenues alone. A key advantage of subscription systems is that they can offer a compelling value proposition to subscribers by aggregating content from many authors, while avoiding the difficult problem of separately pricing individual items of content. However, this raises further complications in determining how to compensate authors and other contributors, which also may include editors and affiliates.

Typically, each publisher builds a complex and highly customized web application to support a subscription model, because there is no comprehensive, pre-fabricated infrastructure available that provides all of the necessary functions. These functions include payment processing, subscription management, controlling restricted access to content, usage monitoring, accounting, reporting, and compensation. The construction of an efficient, reliable subscription system providing all of these functions is expensive and technically challenging.

The architecture of online subscription systems varies considerably, because they generally are tailored to an individual publisher's particular type of content and choice of business model. Netflix, for example, streams movies, TV shows, and other high-end video productions, for which it negotiates costly (and risky) license purchase agreements with Hollywood studios and production companies. On the other hand, major news organizations such as The Wall St. Journal and NY Times have salaried staffs of reporters and editors to produce most of their own material. However, neither of these business models is particularly well-suited to the creation of subscription publications composed of diverse material from many small, independent content providers.

A variety of general purpose designs for online subscription services have been proposed, with significant architectural differences relating both to their models of compensation and to the way that these systems are integrated into the broader landscape of existing web sites and technologies. One of the key differences is the extent to which subscription functions are centralized or decentralized. In centralized systems, a single entity takes responsibility for hosting and serving digital content, managing payment processing and compensation, and supporting related accounting and reporting functions. Decentralized systems generally separate the hosting and delivery of content from other subscription support functions, acting primarily as a clearinghouse to ensure protection of digital rights and guarantee compensation of copyright holders. This often entails incorporating specialized hardware and software mechanisms for enforcing digital rights management (DRM) and securely propagating information between independent computer systems.

Another aspect of considerable variability between different subscription systems is the roles that they support and the basis for compensating those roles. In some systems, for example, subscribers are also content providers, and compensation may be based on voting. Other systems use a combination of subjective criteria and usage-based metrics to determine author compensation. Few systems support automated, usage-based compensation of editors, although editors play an important role when combining large amounts of material from many independent content providers. Affiliates can provide valuable marketing services, so there may exist provisions for affiliate compensation at the time of subscription purchase, and affiliates also may receive further compensation based on some sort of tracking mechanism. Finally, while publishers often build their own facilities for supporting subscriptions, it is also possible that the subscription processing infrastructure may be provided as a fee-based service to independent publishers.

Creators and publishers of digital content are finding it increasingly difficult to profit from on-line sale, but not for lack of talent or interest in their material. Rather, as the internet grows, there is more competition, much of it free, and it becomes harder for a single author or publication to be seen. While e-commerce gets ever more complicated and advertising grows more profuse, many content providers have failed to receive significant revenue. Authors and artists are most aware of these problems, but ultimately everyone suffers from the lack of an efficient market for digital content, ranging from, but not limited to, videos and music to software, photographs, documents and news.

Cable television, which emerged in an environment previously dominated by free, ad-driven broadcasting, has proven people's willingness to pay for subscriptions. Likewise, despite the dominance of free, ad-driven web content, some publishers have established highly successful web-based subscription services, such as Consumer Reports Online and America's Best Colleges from U.S. News & World Report. Ongoing interest in alternative models of “software as a service” further indicates that subscription Internet services are on the upswing and far from any inherent limits.

With the growth in high-speed networking, users clamor for good material, while ever-expanding communities of bloggers and creative content producers yearn for adequate compensation. The convergence of these trends, both on the supply side and the demand side, coupled with the falling cost of the required technology, opens up the possibility of a major new avenue of micro-commerce in digital content.

A number of non-commercial, academic, and social networking sites have successfully brought together the work of many individual contributors to create valuable, free information resources. Wikipedia, MIT's Open Courseware, and YouTube are notable examples. In such systems, where there is no direct compensation to authors and editors, people's willingness to contribute their efforts depends upon recognition of the significance of their contributions.

Bettinger, in U.S. Pat. No. 8,095,467, describes a computerized system for gathering multi-media news and information items from a plurality of sources and disseminating these to a plurality of viewers, while metering usage and using this information as the basis for continuous, real time compensation to submitters of content. Bettinger deals with automated procedures for accepting submissions, indexing, cataloging, layout, and placement of multi-media expositions in relation to advertising and funding sources. Bettinger does not address compensation in subscription-based systems, including compensation to editors and affiliates, nor does Bettinger specify a method ensuring that the system is trustworthy and resistant to abuse.

Huffman, et al., in U.S. Pat. No. 7,505,936, discloses a system for determining and using “conditioning coefficients” to allocate subscription revenues for a collection of digital works. The conditioning coefficient essentially is a weighting factor representing a measure of marketability, which may be combined with usage information to determine royalty payments to be made to the creator of an item of content. Huffman describes a decentralized model, where the conditioning system is separate from independent systems that handle content distribution and author compensation, requiring secure communication of usage and accounting information between trusted intermediaries across a network. Huffman does not address editor and affiliate compensation, nor does it describe a method of direct usage accounting that enables dynamic adjustment of incremental payouts, so as to maintain a correspondence to the relative distribution of usage of various items of content over the entire life of each subscription.

Stefik, et al., in U.S. Pat. No. 7,065,505, describes a method of packaging and distributing digital works with digital tickets specifying one or more sets of usage rights and associated fees, in order to restrict usage and cause transactions to be generated in connection with authorized use. Stefik does not address accounting and compensation in subscription-based systems that provide access to entire collections of digital works from multiple copyright holders, nor does it deal with compensation to editors and affiliates. Pedersen et al., in U.S. Patent Application No. 20110225029, proposes a subscription-based system for publishing digital works and compensating authors (who are also subscribers) based on the number of times their work is downloaded by other members. Pedersen includes no provisions for editor compensation, but it does provide for what amounts to a form of affiliate compensation for referrals leading to new subscriptions, as well as referrals leading to subscriber usage. Pederson does not address time-based usage metrics or streaming video/audio content, nor does it provide for methods of verifying and auditing its accounting and compensation formulas or ensuring resistance to abuse. Pederson does not disclose a method of usage monitoring and accounting that enables incremental payouts reflecting the relative distribution of usage of various items of content over the entire life of each subscription.

Shelton, in U.S. Patent Application No. 20070073625, proposes a system for pooling patents and other intellectual property assets to assemble a portfolio of complementary assets belonging to a number of owners, negotiate royalties with prospective licensees, and allocate royalty revenues among the owners of those assets. Shelton addresses various patent-specific considerations relating to the determination of license royalty amounts and formulas for apportionment of those royalties. Shelton deals only with the narrow domain of patent pooling and licensing, not providing access to digital content in general, nor to subscription-based online publications in particular. Shelton's basis for allocating compensation to owners is entirely negotiated, item by item, not automatically determined from web server usage monitoring.

### OBJECTS AND SUMMARY OF THE DISCLOSURE

It is therefore an object of the present disclosure to provide a method and apparatus for fairly apportioning credit, either monetary or non-monetary, to authors, editors, and other contributors to a collective body of digital content. In a non-commercial context, this would promote greater participation by contributing authors and editors, leading to improvements in the quality and quantity of content. In a commercial context, this would provide the basis for generating a revenue stream for digital content, with automated compensation to all interested parties.

There exists a large, unmet need for systems of digital commerce that better enable the monetization of content that is too valuable to give away freely, but too specialized to generate significant ad revenues, and not of sufficiently prominent stature to sell profitably on an “a la carte” basis. The present disclosure addresses this need through a novel, practical design for building subscription-based services that offer convenience and compelling value to consumers, while rewarding content providers and other participants in the value chain in a way that is perceived as fair, verifiable, and resistant to abuse. Such a system has the potential to greatly expand commerce in information, both commercially and in an academic setting.

### BRIEF DESCRIPTION OF THE DRAWINGS

Further objects and advantages of the disclosure will become apparent from the following description and from the accompanying drawings, wherein:

FIG. 1 is a schematic of the processing of subscriptions according to the present disclosure.

FIGS. 2 and 3 are diagrams of further typical hardware used by the present disclosure.

FIG. 4 is a schematic of a typical implementation of the system of the present disclosure.

FIG. 5 is a schematic of data transformation steps of the implementation of the system of FIG. 4

FIG. 6 is a diagram of a typical URL which may be used with the present disclosure.

FIG. 7 is a diagram of typical processing of the incoming request for URL for the present disclosure.

FIGS. 8-11 are diagrams of typical processing used by the present disclosure.

FIG. 12 is an example of a single database queue pointing to multiple payload tables with different record layouts, applicable to an embodiment of the system of the present disclosure.

FIG. 13 is an example of a queue structure, further illustrating the instruction layout, applicable to an embodiment of the system of the present disclosure.

FIG. 14 is an example of an active database queue with delayed deletions, applicable to an embodiment of the system of the present disclosure.

FIG. 15 is a state diagram of state transitions of the database queue item status, applicable to an embodiment of the system of the present disclosure.

FIG. 16 is a flow diagram of high speed queuing operation, applicable to an embodiment of the system of the present disclosure.

### DETAILED DESCRIPTION OF THE PREFERRED EMBODIMENTS

Referring now to the drawings in detail wherein like numerals indicate like elements throughout the several views, there are two stages of processing that determine how money passes through the system 10.

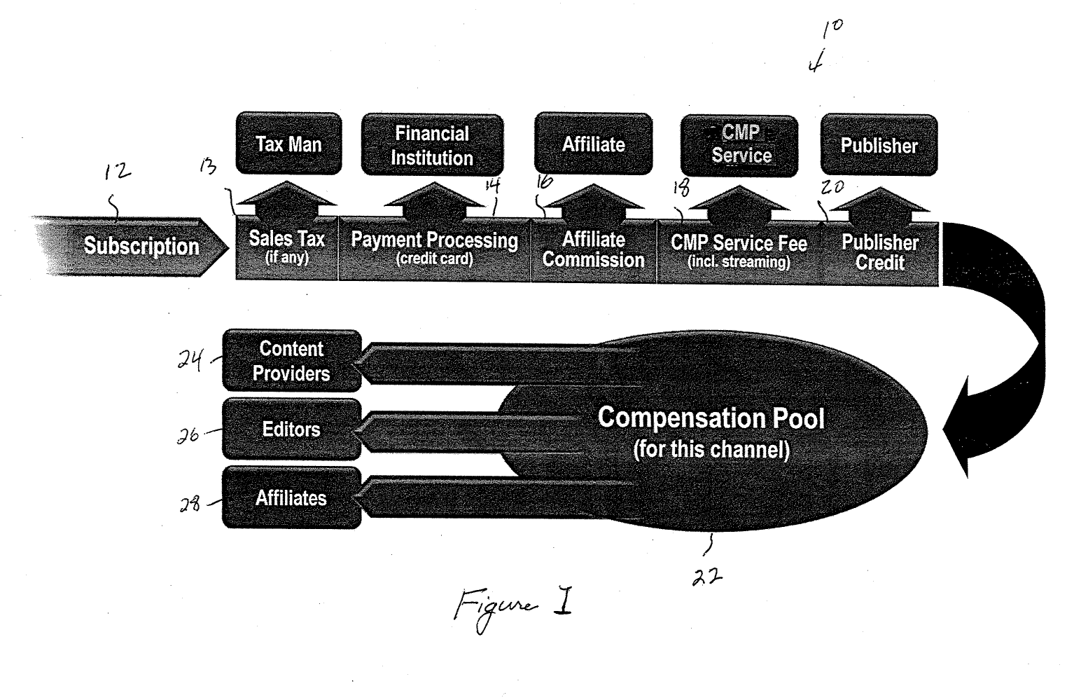

As shown in FIG. 1, in the initial processing performed upon completing a subscription purchase transaction thereby generating an income stream 12, portions of the income stream 12 (gross subscription amount) immediately are disbursed or credited (as specified by pre-determined formulas) to various parties:

the tax agent, if applicable, receives a sales tax 13 or similar tax payment.

the financial institution, which receives a fee 14 for payment processing,

the affiliate, if any, entitled to receive a commission 16 on the sale of this subscription

the system service further receives a fee 18, which is typically an agreed-upon percentage for the publication,

the publisher, further receives a credit 20 from the net subscription amount, this credit 20 is typically determined in advance by the publisher.

The balance of the subscription, after the preceding subtractions, is credited to a system-managed pool of funds 22 devoted to compensating producers of that publication. For each publication, such an account is used in a periodic, post-subscription stage of financial processing, when the system credits funds to the associated content providers 24, editors 26, and affiliates 28.

In other words, the steps illustrated in FIG. 1 determine the amount to be disbursed from the pool to cover usage in the current accounting period. This is the total pool amount divided by the average residual duration of subscriptions to this publication. In other words, the amount disbursed will be approximately the pro-rated amount from subscriptions for the duration of the accounting period. For example, if the average subscription has six months remaining and the accounting period is monthly, one sixth of the total pool amount would be disbursed for this month.

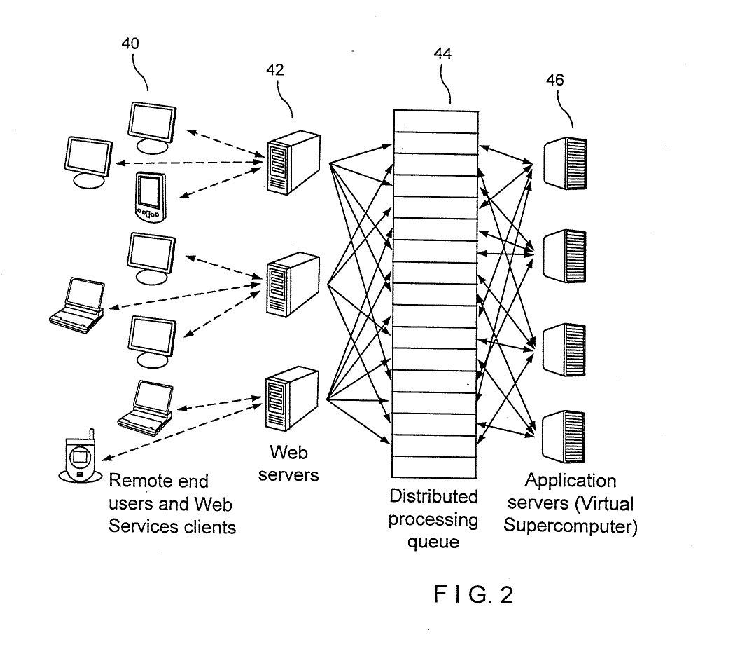

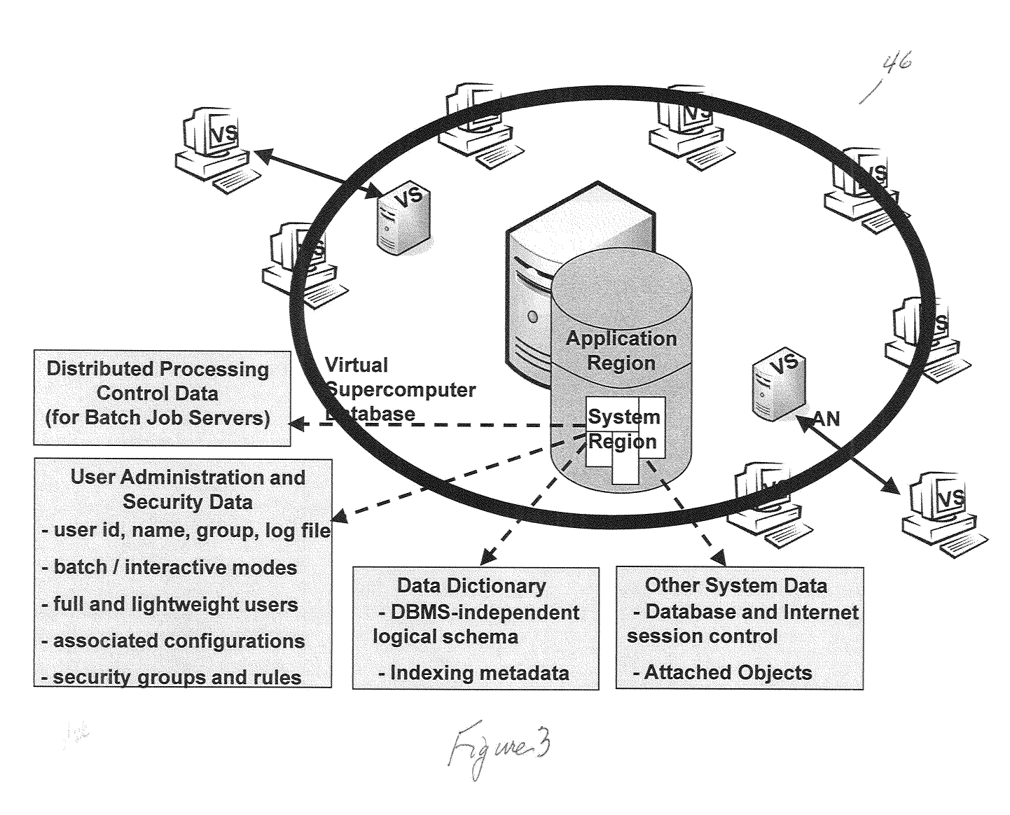

FIGS. 2 and 3 illustrate the typical environment in which the system 10 operates. Remote end users and web services clients 40, using personal computers, mobile devices or similar devices, communicate with web servers 42 which likewise communicate with a distributed processing queue 44 which is implemented by application servers 46, which typically form a virtual supercomputer. The queue 44 is a database table, whose records point to other records in other tables, as will be explained later in more detail. The application servers typically pick up tasks in first-in-first-out order to perform tasks, flag tasks as done and delete records periodically. As further shown in FIG. 3, the application servers 46 form a virtual super computer which performs the various tasks as distributed processing control data, user administration and security data, maintain a data dictionary and maintaining other system data.

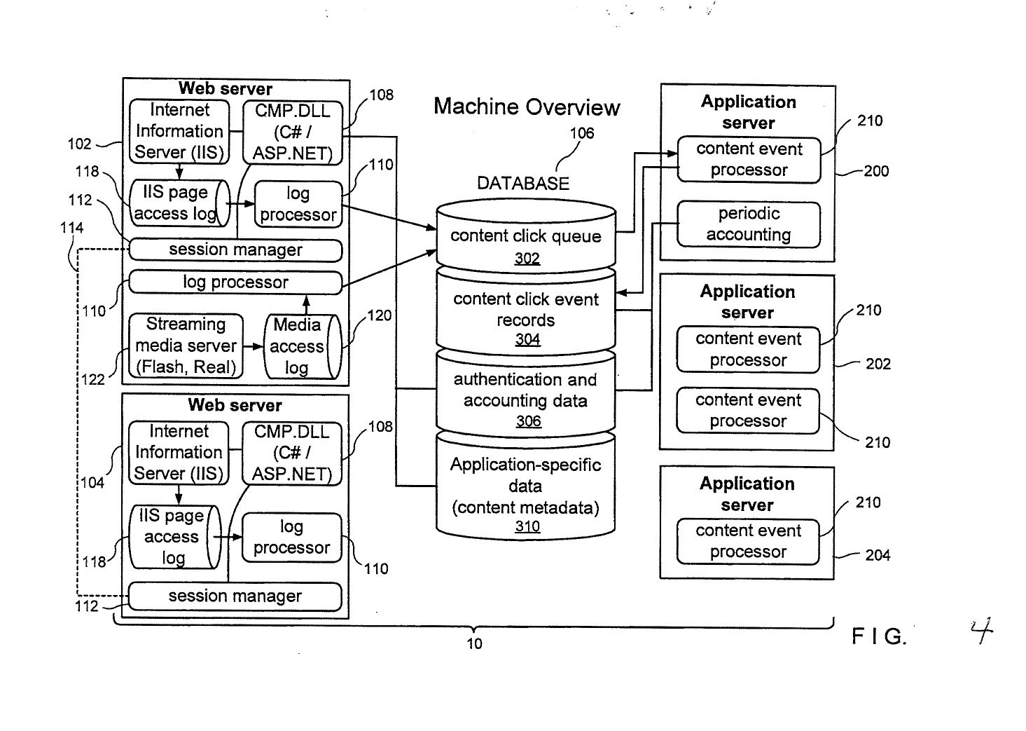

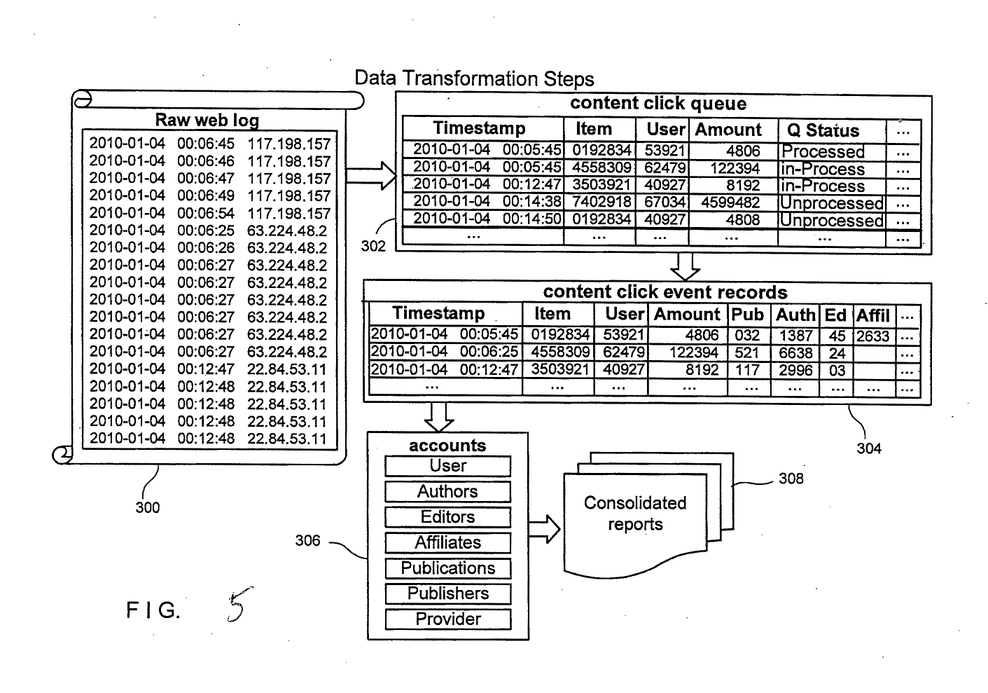

FIGS. 4 and 5 illustrate a typical implementation of system 10. This implementation of system 10 can incorporate the apparatus and method disclosed in Published U.S. Patent Application No. 2008/0263106 A1, entitled “Database Queuing and Distributed Computing” published on Oct. 23, 2008, the contents of which are hereby incorporated by reference.

The system 10 comprises various types and configurations of server computers using software and data structures to support the model of subscription-based micro-commerce. Web servers 102, 104 are connected through a local area network (LAN) to a shared relational database 106 running on a cluster of database servers, which also is connected through the LAN to a number of application server machines 200, 202, 204. While three application server machines are illustrated, a greater or lesser number is possible. The modular design provides high performance and scalability with commodity hardware and standard systems software. For example, the system 10 has been implemented in a Windows Server/IIS/SQL Server environment.

The job of the system 10 is to serve digital content to users who have subscribed to virtual publications, to process their “content clicks”, to divide up the subscription revenues according to custom formulas, and provide real time reporting and verification of activity and revenues. As shown in FIG. 5, a Content Click Event record in table 304, as derived from one or more records in the content click queue 302, as derived from one or more lines of a raw page access log 118 or streaming media access log 120, represents a click on a “URL”, which may be embedded in an ordinary web page. The URL is a standard web URL or URI that represents a file or set of files with some of a publication's protected content. Additional information for identifying what web page generated the content click is included as query parameters in the URL.

The system 10 performs a series of data transformations, starting from the raw text logs 300 (web page access logs 118 and streaming media access logs 120) produced on a collection of web servers, and culminating in a set of consolidated reports 308 in accordance with the various accounts 306 and the final distribution of credits to various parties according to the system's model of accounting. This provides the basis for an automated system of fair compensation or recognition of merit, based on usage by authenticated subscribers.

Many of the web server machines, in addition to running standard web server software, such as IIS (Internet Information Server), run one or more types of streaming media server software, for example, but not limited to, Adobe Flash Media Server or RealVideo streaming server. Each of these types of server software typically generates a plain text log file, including numerous details about every page access or increment of streaming activity that occurred. The format of server logs is typically flexible, well documented, and standardized by the World Wide Web Consortium (W3C).

Each web server machine 102, 104 also runs an instance of the CMP.DLL software component 108, typically written in C# and ASP.NET, for dynamic generation of web pages, downloadable documents, images, software, and video and sound streams. The primary function of CMP.DLL 108 is to retrieve a piece of content given its unique Item ID. The web server machines 102, 104 host the pages for the web site.

A call to the functions or subroutines of CMP.DLL 108 downloads a file with protected content. CMP.DLL 108 also supports subroutines for providing access to streaming content, possibly through a browser widget for the type of protected content being streamed (video or sound) that is appropriate for the client device (PC, mobile phone, etc.) Corresponding versions of these functions or subroutines also provide a low-level programmer's interface (API) for escaping default behaviors, such as automatically displaying the returned content in the user's browser or displaying a logon dialog as the method of authentication.

These functions or subroutines also support optional query parameters for specifying an affiliate numeric code or character ID and attaching an annotation (e.g. for A/B testing and categorizing the pages where the click originated). Useful information that is known to CMP.DLL 108, for example the user ID, or the fact that a particular request triggered a subscription purchase, is incorporated into the web log, so this can later be extracted by the Log Processor 110. The system's subscription model typically requires user authentication, and this is handled by CMP.DLL 108 through an initial login dialog, using session cookies to keep track of an already logged-in user.

As a further refinement, the system session manager 112 provides a high-speed mechanism for detecting and preventing multiple concurrent logins of a single user on different machines. The system session managers 112 running on separate web servers 112 use a direct channel of communication 114 (typically through TCP/IP) to maintain a global, in-memory list of active user sessions. If a user is already logged in on another machine (such as 102 or 104), that session will automatically be terminated (if it hasn't already timed out) when the same user logs in on a different machine. This protects against the abuse of illegally sharing registered user credentials (user names and passwords).

For each web server page access log 118 or streaming media access log 120, there is a Log Processor 110 running on the web server 102, 104. The log processor 110 captures information from the web log as quickly and unobtrusively as possible, passing selected information along for further processing, in the content click queue 302 (see FIG. 5). Prior to pushing the click information to the queue, the log processor combines clicks for closely spaced streaming events (such as when a subscriber presses pause and then plays more shortly afterwards) into single logical click events, for reporting and analysis convenience.

The log processor 110 is a background process that stores its state in the database and regularly reads newly added log items and adds them into a content click queue 302. A single content click queue is sufficient 302, but content click queues 302 can be added to the system 10 as volume or special case handling arises. By keeping track of the log file last read, the byte offset into the log file, and the currently active log file format, the log processor 110 can proceed efficiently through the log files while typically guaranteeing that no content clicks get lost.

The log processors 110 take advantage of an accounting model that permits a high degree of parallel processing. There is no rigid order in which individual content clicks must be processed, so long as the processing for the period in question has completed when the final accounting is done. This could be daily, weekly, or monthly—in the meantime, log processing can be distributed across a large number of concurrent threads, processes, and servers.

Because web logs 118, 120 can grow very rapidly under heavy server load, it is important that the log processor 110 keep up with its job without over-burdening the web servers 102, 104. It is also important that the processing of web logs 118, 120 be highly reliable and resistant to failures, because the information generated may ultimately determine monetary compensation. In database terminology, this means that actions upon the content click queue 302 typically must be “transactional”.

In order to achieve the desired high performance and recoverability, the log processors 110 employ multiple threads to write to the content click queue 302. A single log reader thread for each log is sufficient, and this simplifies the design. The writer threads each must execute a transaction in writing to the queue, but the cost of such transactions can be minimized by keeping them small and localized.

To assist in achieving high performance and scalability, content click queues 302 are implemented using a database queuing method and apparatus that supports large-scale, reliable service-oriented architecture, as described in the above-identified Published U.S. Patent Application No. 2008/0263106 A1.

The Log Processor 110 adds (“pushes”) content click information into a content click queue 302 as a way to request a unit of work. The queue 302 is a database table with records that point to other records in other tables. Entries are read and removed (“popped”) from the queue by application servers 200, 202, 204 as the work is completed. These servers 200, 202, 204 pick up the content click information in first-in-first-out order and process it, creating and generating output to content click event records 304. Once this processing has been done, the corresponding queue records are flagged as having been processed. Processed items in the content click queue and their associated data are periodically deleted, as they are no longer needed. Database-oriented queuing takes advantage of database strengths such as indexing, synchronization, transaction processing, reliability, and recovery features.

In order to minimize the burden on web servers 102, 104, the bulk of the accounting job is handled by a separate, adjustable pool of application servers 200, 202, 204. The main task of these application servers is to run one or more instances of the content event processors 210. Less frequently, the application servers may run periodic accounting functions.

The content event processors 210 do the processing required to remove an item from the content click queue 302 and generate corresponding information in the content click event records 304. The object of this processing is to determine all of the quantities and identifiers needed to properly credit this increment of download or streaming activity. Some queue items can simply be discarded, and some accumulated into existing content click event records.

Some information is directly captured in the web page access logs 118 and media access logs 120 and transferred to the content click queue 302, and some data is derived from that information, in combination with administrative/accounting data 306 or metadata 310. Such additional steps as affiliate code validation, identification of the senior editor, and other accounting requirements are handled by the content event processors 210. The end result will be a content click event table (see 304, FIG. 5) sufficiently detailed to enable complete determination of all affected accounts through simple SQL queries against table 304 in conjunction with related accounting data and metadata, consolidating these individual content click events into useful aggregations.

The content event processor 210 is responsible for setting the most important content click result codes stored in the content click event records 304:
“Paid click”: Successful, creditable click by a paying subscriber, where the click date is greater than the subscription's start date. Typically no click already exists for this subscriber and content item in the same accounting period. A new paid click can occur for the same subscriber each time his subscription is renewed if he downloads or streams the content item again. Content providers, editors, and affiliates (i.e., those who host websites instrumental in the transactions) receive compensation for paid clicks, and the content click event record 304 includes a Paid Download Byte Count or a Paid Stream Duration Seconds.
“Repeat click”: Paying subscriber successfully clicks again on the same item during the subscription period, but the click is not creditable. No payments are made for a Repeat click, but Repeat clicks do count against the subscription's maximum, if any, for that end user.
“Cancel or fail click”: Paying subscriber is authenticated but download does not complete successfully or user cancelled download (after launching). For streaming, a small, minimum number of seconds or less of play may have occurred (e.g. because the initial frame was downloaded, but the user didn't press Play).

On the other hand, some of the less important Content Click Result codes do not require determination by the Content Event Processor, because they will have already been handled by CMP.DLL 108. These are Content Click Result codes such as:

“Non subscriber click”: Click by a non-paying user, such as a publisher, editor, content provider (for their own content), administrator, etc. (Typically, merely being an affiliate does not give one the right to freely access a publication's contents.) For non-subscribers, no distinction is made between successful or cancelled/failed clicks.

“Expired subscription”: User is authenticated but his subscription to this publication has expired, and he terminated the session without buying a subscription.

“No subscription”: User is authenticated but does not have a subscription to this publication, and he terminated the session without buying a subscription.

Web page access logs 118 and streaming media server logs 120 contain the raw information, in simple text form, from which a complete accounting must be derived. These raw web logs 300 include various standard, generic items of information, such as date/time, IP address, requested URL, number of bytes transmitted, etc. CMP.DLL 108 also causes additional items to be incorporated into these logs, for example the authenticated user id and a purchase code, if applicable. Thus CMP.DLL 108 ensures that the logs 300 contain sufficient information to support the system's accounting model. The raw web logs 300 are generated quickly, and they provide an authoritative basis for auditing, but information in this form, plain text, is unwieldy for analysis and accounting purposes.

The first stage of transformation is to analyze the log 300, and put the essential information into a more structured, tabular form, the content click queue 302, which resides in a shared database 106. A record of the content click queue corresponds roughly to a single line of text from a raw web log 300, parsed into regular columns of information. Conceptually, one can envision the content click queue 302 as a single table, but its implementation may actually entail several inter-linked tables.

As an optimization, successive log entries relating to the same user and item may be combined, so there will generally be fewer records in the content click queue 302 than the number of lines of raw log data. This is especially useful for streaming, so that multiple clicks that represent stopping and starting a single stream can be consolidated into a single content click event.

Only the information that pertains to accounting for creditable activity needs to be put into the content click queue 302. The fastest possible log processing can be done on the web server 102, 104 itself, where the log is locally accessible, but the amount of processing required for this initial transformation must be kept small, to minimize degradation of web server performance.

Once the data has entered into the content click queue 302, the further stages of transformation it must undergo can be performed entirely apart from the web servers 102, 104, by a separate group of application server computers 200, 202, 204. In this way, the accounting system can be expected to have minimal impact on web server performance, and the queue-based, parallel processing architecture assures a high degree of scalability.

Application servers 200, 202, 204 run the software of the content event processor 210 to generate content click event records 304 from entries in the content click queue 302. There will typically be fewer event records than queue items, because some will effectively be combined or discarded. Additional processing is needed in certain cases, for example to validate an affiliate id, or to determine the identity of the associated editor(s). Some items of account data, e.g. total bytes streamed by a given user, are maintained on an ongoing basis, in order to enforce usage limits and provide useful quick reporting statistics.

Periodically, the system 10 must perform a set of accounting jobs. These entail updating account information for all parties concerned, making a final determination as to the distribution of credits as of this accounting period. This information is presented to participating authors, editors, publishers, and affiliates through various summary reports 308. The ultimate outcome, in a commercial context, is that the various parties are compensated in the amount prescribed by the accounting model of the system 10. Because of the continued availability of the detailed content click event records 304, the final output (compensation to the publishers, content providers, editors, and affiliates) can be tested and audited easily.

The session manager 112 is used by the CMP.DLL 108 to prevent both multiple logons by the same user and attempts to circumvent logon. It is responsible for keeping track of the users currently doing database access on the web server machine. Security calls typically are made using Microsoft's COM interface.

The session manager 112 keeps track of database sessions. It maintains an internal list to track who's logged in for any applications on the same web server. The session manager is typically not directly connected to the central database 106, and it depends on CMP.DLL 108 or other components to perform actual database operations on database session records. Database session records track who is logged on, through what application and which web server machine.

The session manager 112 keeps database session information in memory and provides an interface for determining session validity and forcing off sessions, which may be on other machines. The session manager is responsible for communicating between different servers to ensure that a user can be forced off regardless of which web server machine is handling the session.

The session manager 112 acts as a persistent memory store, with a COM interface available to programs on the web server. The Session Manager supports four Database Session functions: RegisterDbSession, UnregisterDbSession, GetDbSessionStatCod, and ForceOffDbSession. Database sessions are uniquely identified by User ID plus Logon Date and Time, all of which are required as parameters to these function and are stored as part of the user's web session information.

The internal Database Session List has an entry for each session: Logon User ID, Logon User Date and Time, ForceOffFlag, Last Visit Date and Time, Application Time-Out Minutes. The Last Visit Date and Time are updated every time the status of the Database Session is checked. The time-out period is checked against the last visit to determine whether the session has expired. The Session Manager 112 assists CMP.DLL 108 in cleaning up database session records that have been left over because of a crash or web session time-out.

There is one database session record per logged on user. Each record includes a User ID, a Logon Date and Time, Application Name (i.e. what executable or web site), and Application Version. By displaying these records, administrators can view a list of all the users and applications logged on to the current database. The Database Session record includes addressing information identifying the web server machine through which a user is coming. Therefore, a target Session Manager can be located from the Database Session record containing a duplicate User ID. This allows one Session Manager to provide the service of sending a message to a different Session Manager that instructs it either to terminate processing immediately for that user or to set a flag to terminate processing the next time there a web request from that user. This enables the CMP.DLL on a different web server machine to do the job of forcing off the “offending” (old, invalid, extra) instance of the user at the earliest possible moment.

CMP.DLL 108 checks the session status every time a page request requiring a user logon is received. The GetDbSessionStatCod (Get Database Session Status Code) function has three return values: DbSessionStatValid, DbSessionStatNotValid (not found or timed out), and DbSessionStatForceOff. If “ForceOff” is received, the CMP.DLL 108 terminates this user session, and returns the user to the Logon form, with an appropriate message.

The above-identified apparatus and method, as disclosed in Published U.S. Patent Application No. 2008/0263106 A1, entitled “Database Queuing and Distributed Computing” published on Oct. 23, 2008, can be implemented within the system 10, the contents of which are hereby incorporated by reference.

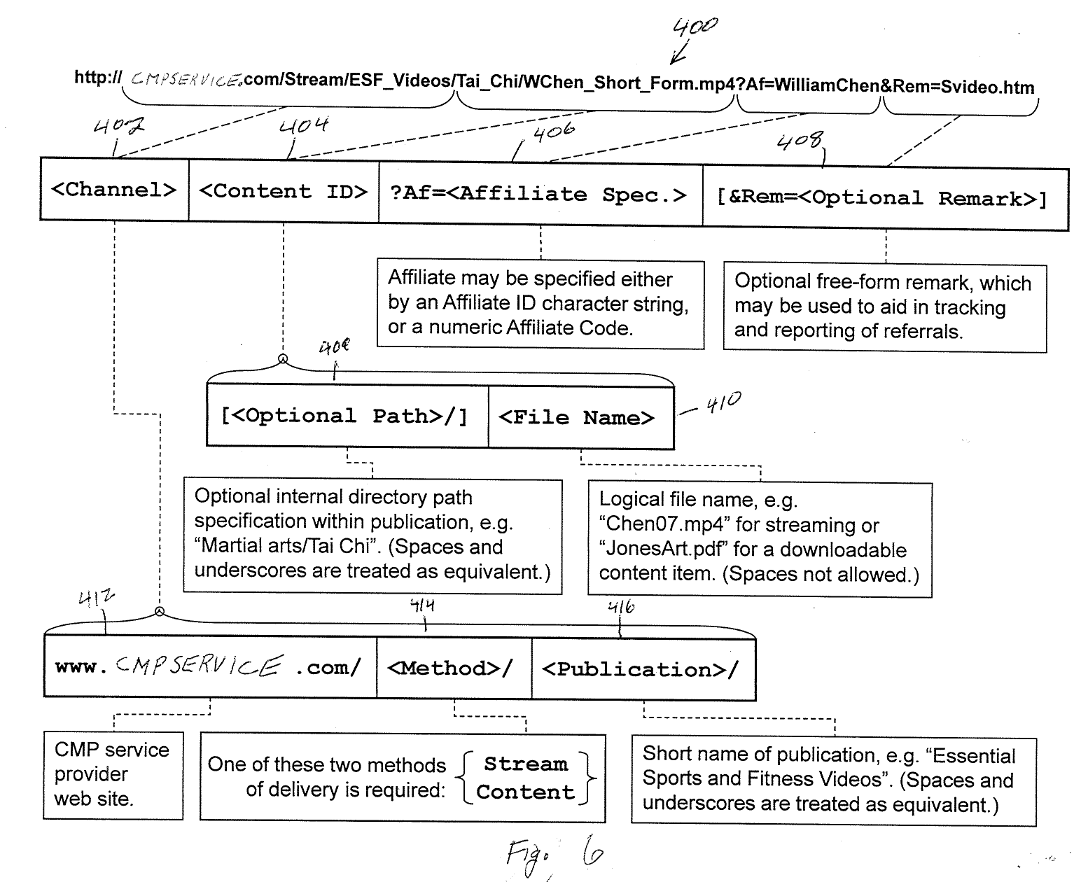

An example of a URL 400 for an embodiment of this disclosure is given in FIG. 6. A URL is a link to the CMP Service that specifies a channel 402 (with a method of delivery), a content item 404, and, usually, has one or two query parameters, an affiliate web site identifier 406 and an optional affiliate-specified Remark string 408.

A URL 400 resolves to a content item 410 hosted by the CMP Service. A content item is a single file, and its extension (the righthand side of the period character in the file name) indicates its logical format (e.g. “.mp4” for video, “.pdf” for article, and “.zip” for software product). A single DVD, for example, is likely to be divided into multiple content items based on a breakdown of the DVD into convenient portions.

The subscriber links to items of content in a CMP-hosted channel or publication just as he or she would construct links to other external web sites. The user can determine the URL 400 to use by locating the corresponding entry for the item in question in the online publication that contains it. By way of non-limiting example, URLs 400 may begin with “http://cmpservice.com/” or “http://www.cmpservice.com/”. This is followed by “Content/” or “Stream/”, depending on whether the item is a downloadable file or a segment of streaming media, respectively. The next part of the URL specifies the short name of the publication, terminated by a slash, and then a content id. The rightmost portion of the content id is a valid Windows file name, and this may be preceded by a hierarchical path, delimited by forward slash characters. For example, the URL might resemble this:

http://cmpservice.com/Content/CG_Sports/Fishing/Gone_Fishing.pdf

where the publication short name is “CG_Sports” and the content id is “Fishing/Gone_Fishing.pdf”. Note that URLs 400 are case-insensitive, but mixed case typically is used for clarity.

When links are created from a referring (affiliate) web site to items of content in CMP-hosted channels, an additional piece of information is appended to the URL for each item to which is referred, in order to indicate the affiliate ID 406. When an affiliate is registered, the affiliate is assigned a unique numeric affiliate code and corresponding mnemonic ID, either of which typically may be specified via the “Af=” query parameter. For example, the following URL would be associated with affiliate #1234.

http://cmpservice.com/Content/CG_Sports/Fishing/Gone_Fishing.pdf?Af=1234

A registered CMP Service affiliate (see FIG. 1, element 28) will be credited for both new subscriptions and usage by existing subscribers to publication content visited through the affiliate's links. The affiliate can monitor affiliate referrals and track earnings online, and receive regular payments from the system, just as content providers.

Another piece of useful information that can be attached to a content item URL 400, in addition to the affiliate ID 406, is a short tag or remark 408, specified through the “Rem=” query parameter. To specify query parameters on a content item URL, append a “?” character, followed by one or more query parameter assignments, separated by “&”. For example, to specify affiliate #1234 and the remark “Xyz”, a URL 400 of this form might be used. http://cmpservice.com/Content/CG_Sports/Fishing/Gone_Fishing.pdf?Af=1234&Rem=Xyz

Remarks may be used for A/B testing, or to identify the exact location where this link was found. The system's account monitoring facilities include a breakdown by remark, so this field can be an aid in tracking referrals.

A sample URL might be: http://cmpservice.com/Stream/Essential_Sports_and_Fitness_Videos/Tai_Chi/William_Chen_Short_Form_DVD_{—}06_Split_Screen.mp4?Af=PeterHerman&Rem=subscription.html102

1) CMP service web address: http://cmpservice.com (see 412)

2) Method of delivery: Stream (see 414)

3) Publication (channel's) short name is: Essential Sports and Fitness Videos (see 416)

4) Content ID is: Tai Chi/Wiliam_Chen_Short_Form_DVD_{—}06_Split_Screen.mp4
4a) Content ID Path part: Tai Chi (see 409)
4b) Content ID File Name part: (see 410) Wiliam_Chen_Short_Form_DVD_{—}06_Split_Screen.mp4

5) Affiliate ID: PeterHerman (see 406)

6) URL Remark (URL Remark Parameter): subscription.htm102 (see 408)

The URL 400 starts with the web address of the CMP Service and is followed by the method of delivery. This is either streaming, indicated by the keyword “stream” or download of the item, indicated by the keyword “content”. All URLs 400 for a given CMP Service resolve to one of two private web pages: one for download (e.g. GetContent.aspx) and the other for streaming (e.g. GetStream.aspx).

The content item of a URL 400 is specified by a combination of the publication (channel) name 402 and the Content Id 404 of the particular content. This is sufficient to uniquely locate the content item.

Each content item in a publication is uniquely identified by its Content ID (case-insensitive). The Content ID portion 404 of the URL 404 comprises a logical file name and an optional, prefixing, logical “path” (i.e. modeled after the Windows and Unix filing system conventions). Content IDs form a content “tree” (hierarchy) that provides a basic organization for the publication. By convention, forward slash (/) is the directory (node, component) separator.

Every channel has a unique Publication Short Name 416, Publication Code, and Publication Name. Internally, the publication name is converted into a Publication Code, and the Content ID 404 is converted into a Content Code plus a logical content file name.

The publication 416 and Content Id Path 404 can use either single spaces or single underscores to separate tokens. Underscores are recommended in the UR 400L. The Content ID File Name 404 (on the right) must use underscores instead of spaces, so that it is a single token. Underscores in the publication name and left hand portion of the Content Id (file path) 404 are converted to spaces for internal storage and display purposes.

Query parameters are optional in a URL 400, and a single Affiliate (Af) query parameter 406 or a single Remark (Rem) parameter 408 or both may be present.

The Affiliate query parameter 406 indicates who should be credited for the content retrieval and/or subscription sale. No Affiliate should be specified as part of links on the publisher's own web site or on the CMP Service web site. On the other hand, all other web sites should include an Affiliate ID 406 or Affiliate Code in any URLs 400, as should publishers who embed URLs 400 that are for channels other than their own. The Affiliate query parameter of a URL 400 determines who, if anyone gets paid for causing a subscription or a viewing/download of protected content (ClickEvent).

The AffiliateEntityCode or AffiliateId cannot be the same as the publisher or the CMP Service. (A publisher typically never gets affiliate credit for directly selling content in its own publications. The CMP Service typically never gets affiliate credit for any subscription sales or paying content clicks done through its own web site.)

Every affiliate gets both an alphabetic Affiliate ID and a numeric Affiliate Entity Code and can use either in the Affiliate query parameter. For example, these two URLs are equivalent (assuming affiliate “Base One” has a code of “1002”):
http://www.cmpservice.com/Content/CG_Sports_Performance_Article/Fishing/Gone_Fishing.pdf?Af=BaseOne
http://www.cmpservice.com/Content/CG_Sports_Performance_Article/Fishing/Gone_Fishing.pdf?Af=1002

The URL Remark parameter 408 can be used by the affiliate or publisher to identify the source web page, i.e. the page the subscriber was on when requesting a particular content item (or channel). It appears in reports and is useful for tracking the web page from which the click originated. It's also useful for A/B comparison testing, for experiments in altering a page to figure out what gets the most action.

For example, “home_page” is appended by an affiliate (or editor) to indicate that this link is located on the web site's home page:
http://www.cmpservice.com/Content/CG_Sports_Performance/Fishing/Gone_Fishing.pdf?Af=BaseOne&Rem=home_page

For example, the link to the same content follows, but on a page of the public part of the CMP web site, CGWPagContentFishing.aspx, with a different Remark:
http://www.cmpservice.com/Content/CG_Sports_Performance/Fishing/Gone_Fishing.pdf?Rem=CGWPagContentFishing

URLs 400 include a Publication Short Name 416 and Content ID 404 to specify a content item. In brief, the format of a URL 400 follows:
http://www.cmpservice.com/[Content|Stream]/[PublicationShortName]/[ContentID][?Optionalqueryparameters]
   URLs 400 are broken down internally into separate components that have individual validation rules:
1) CMP Service Web Address (see 412)
   e.g. “http://cmpservice.com” OR “ . . . / . . . / . . . ” (relative URL is only for CMP Service)
2) Content Delivery Method (see 414): “Stream” or “Content”
3) Publication Short Name (e.g “Essential Sports and Fitness Videos) (see 416)
4) Content ID (which has two parts, an optional “path” and a required file name) (see 404)
   4a) Content ID Path (e.g. “Tai Chi/” or “Martial arts and fitness/Tai Chi/” (see 409)
   4b) Content ID File Name (e.g. “William_Chen_DVD_{—}06.mp4”) (see 410)
5) Affiliate ID Order Code (e.g. “PeterHerman” or “12345”) (see 406)
6) URL Remark Parameter (e.g. “subscription.htm102” or “home.htm” or “Homepage”) (see 408)

Content ID validation takes place when the editor assigns it. Validation of the Affiliate and Remark is done every time a URL 400 comes into the CMP Service. Here are the typical validation rules:
1. Spaces are not allowed in right-hand, logical file name portion of Content ID.
2. Logical file name must include a file extension and be valid Windows file name format.
3. Hyphen (-) is not allowed in the Content File Name portion of the Content ID
4. Single slash (/) separates the Content ID Path (if present) from the Content ID FileName
5. Single slash (/) separates the Publication Short Name from the Content ID
6. Content ID Path must be a valid Windows path format (specification)
7. Slash (/) can't have a space or underscore next to it
8. Maximum length=150 for Content ID
9. Plus (+) is not allowed in Affiliate ID or URL Remark
10. Maximum length=15 for Affiliate ID Order Code with first character alpha or must be a valid number
11. Maximum length=100 for URL Remark Parameter (“URL Remark”)
12. Backslash (\) is not allowed in any part of the URL
13. URL must contain “/Stream/” or “/Content/”
14. More than one space or underscore between tokens is not allowed anywhere in URL

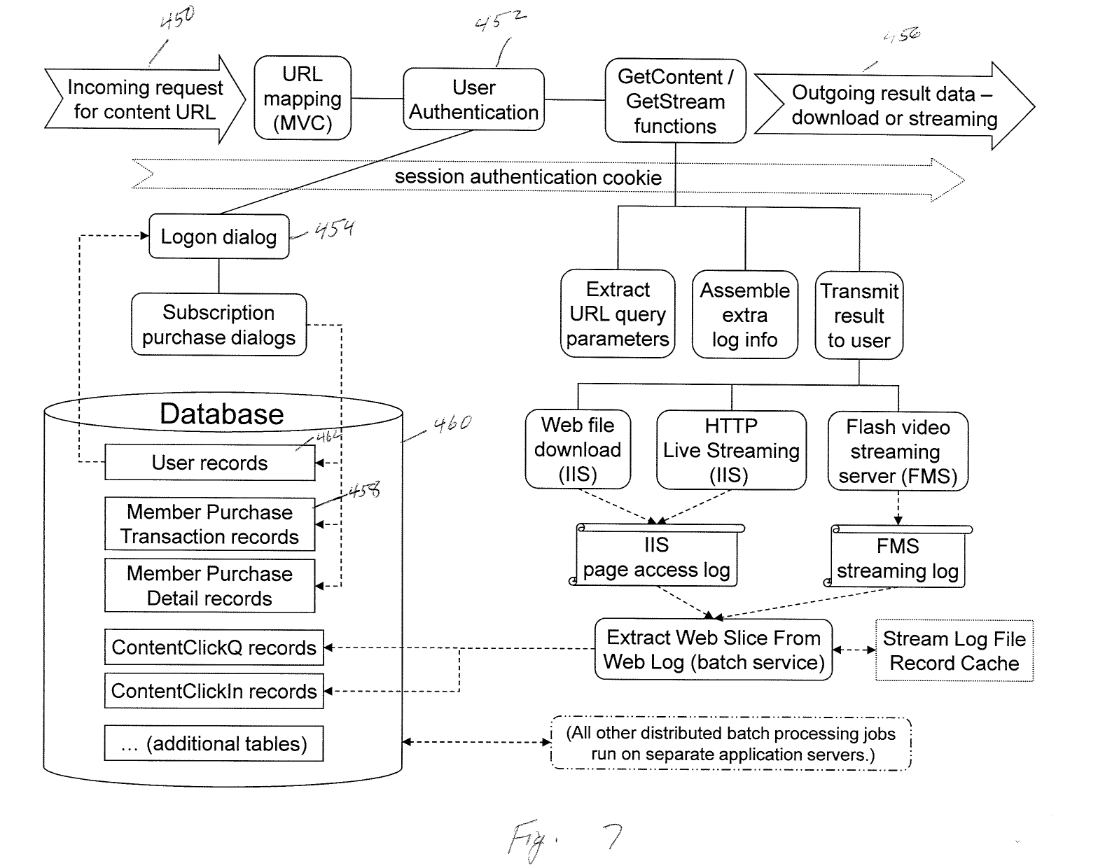

As shown in FIG. 7, as far as the underlying accounting and security goes, the CMP Service's web site has two main functions. First, it creates subscriptions to channels by collecting credit card payments and recording them in the database. Second, it authorizes content usage and tracks clicks on the protected content. As subscribers access content, combined subscription purchase and content usage data is inserted into the web log of the service that delivered the particular content item to the user. This makes it possible for an asynchronous process resident on the web server (but outside of the web site itself) to regularly process each log and combine the native log entries with the extra data inserted into the logs to completely describe content usage. Note that the centralized CMP architecture enables highly efficient capture of detailed usage statistics and secure, rapid transmission of this information into the accounting process, while placing a minimal burden on web servers. This efficiency is needed to support routine, near real-time reporting to stakeholders (authors, editors, and affiliates) as to their ongoing earnings, bolstering the system's credibility and engendering trust.

A click on a URL link (see 450) initiates the CMP Service workflow that makes sure the user has a valid subscription (see 452), if necessary walks the user through the sign up and/or purchase process, delivers the content, and returns the user to the originating web page. When the CMP Service receives a URL click, it directly asks subscribers to logon (see 454) if they haven't already, takes them to the video viewer or download dialog, and takes them directly back to the site with the link. This pattern eliminates the need for web sites that embed these links to launch a separate browser window, because the experience to the user is comparable to using a well-integrated payment processor to collect credit card purchases.

Through the URL, the CMP Service provides what appears to users as an embedded video or download service. It brings traffic back to the originating web site without diversion, making the site “stickier” and appearing to have more content. And this is done without the need to use a programming API or embedding a custom script. (Custom programming is only required if the web site elects to completely hide the CMP Service interaction—so that it appears as resident on the originating web site, as opposed to temporarily taking the user elsewhere and then back.)

The final step in processing a URL click that the CMP Service web site does is to deliver the specific content item, either by streaming or download (see 456). At the start of this step, a comment string is added to the appropriate web log. This contains the URL's Affiliate and Remark query parameters (see FIG. 6, elements 406, 408), plus identifying data about the user, his subscription, the content item, and whether or not a sale was made at that time.

If any CMP Service web page has been reached from an external site that supplies an Affiliate and/or Remark query parameter, then those query parameters are taken over any that may be present on links on the CMP Service's own web site. This insures that the affiliate web site gets paid whether URLs are directly embedded in its web site or it uses links to public pages on the CMP Service that describe the channel, and this page in turn leads directly to a subscription sale or URL access. When present, the outside Affiliate and Remark are the ones recorded and credited.

At the time a subscription to a channel is purchased, the CMP Service web site adds a Member Purchase Detail record (see 458 within database 460) and adds or updates a Publication User record (see 462):

A single Member Purchase Transaction record is associated with one or more associated Member Purchase Detail records. This Member Purchase Transaction record is one of the few that is typically not partitioned by channel (Publication Code). While the subscriber waits the purchase as a whole goes through payment processing, starting with a status of “Submitted pending approval” and ending as either “Approved” or “Declined or error”.

An “Approved” Member Purchase Detail record not only records sale of a particular channel subscription, but also it is used to keep track of usage and enforces bandwidth limits as specified in the Subscription Offer record associated with the purchase. The Member Purchase Detail record includes how much of the actual subscription payment goes into the compensation pool and how much goes to the publisher, the affiliate, the CMP Service, the financial service credit card processing fee, and the applicable sales tax, if any.

There is a Publication User record for each user (member) having any kind of access to a publication (channel). The CMP Service web site automatically adds a Publication User record when a regular user first subscribes to a publication, and this record is updated each time the subscriber renews. The record keeps track of current subscription start and end dates for a given user in a given publication, which is copied from the Member Payment Detail record.

As opposed to a Member Purchase Detail record 458, Publication User records 462 are required not only for paying subscribers, but also for non-paying users, including editors, publishers, and CMP Service staff. Content providers need a Publication User record to exist to access their own content. Affiliates do not automatically get access to a channel's content, and so may or may not have a Publication User record.

At the time a subscription is sold, there is sufficient information to divide up the purchase amount into its basic components for distribution. The CMP Service web site's Publication Cache contains the basics from the database to do rapid translation of Publication Short Name to Publication Code, describe the publication, and divide up purchases. The cache includes the Publication Master's PurchaseShareAmount and PoolPercentShare fields. The following fields are used for calculating how to divide up subscription purchase amount:

PurchasePercentShareCMPService

PurchasePercentShareCompensationPool

PurchasePercentSharePublisher

PoolPercentShareContentProvider

PoolPercentSharePrimaryEditor

PoolPercentShareSeniorEditor

In a typical embodiment, the Affiliate's share is a CMP Service constant, typically twenty percent.

A typical credit card fee is about five percent of the transaction amount. The issue is that there are so many add-ons and special case charges that it is impossible to know the exact cost of a credit card transaction until long after the charge has been made, and even then this requires special processing of statements from the credit card processor. Sales tax may not apply to streaming of videos or downloads of articles, but typically may apply to downloads of software.

The percentage of the member purchase going to the CMP Service after the taxes and credit card processing fees have been subtracted (but before affiliate share) is typically around twenty percent. Additionally a percentage of the member's purchase goes to the publisher after the taxes, affiliate, credit card processing and CMP Service fees have been subtracted. The remainder of the subscription revenues, after the preceding subtractions, goes into the publication channel's compensation pool for allocation to content providers, editors, and affiliates on the basis of metered subscriber usage. These allocations are determined according to publisher-assigned parameters for each channel. The PoolPercentShare for ContentProvider, Primary Editor, plus Senior Editor must equal 80%, assuming a 20% share for affiliates who cause clicks. If no affiliate is involved in a particular piece of usage, the other PoolPercentShare amounts are correspondingly adjusted to allocate the remainder of the credit to the other parties. Likewise if there is no editor or senior editor associated with a given content item, the remaining usage credit is allocated proportionately among the remaining parties, which generally include at least the Content Provider.

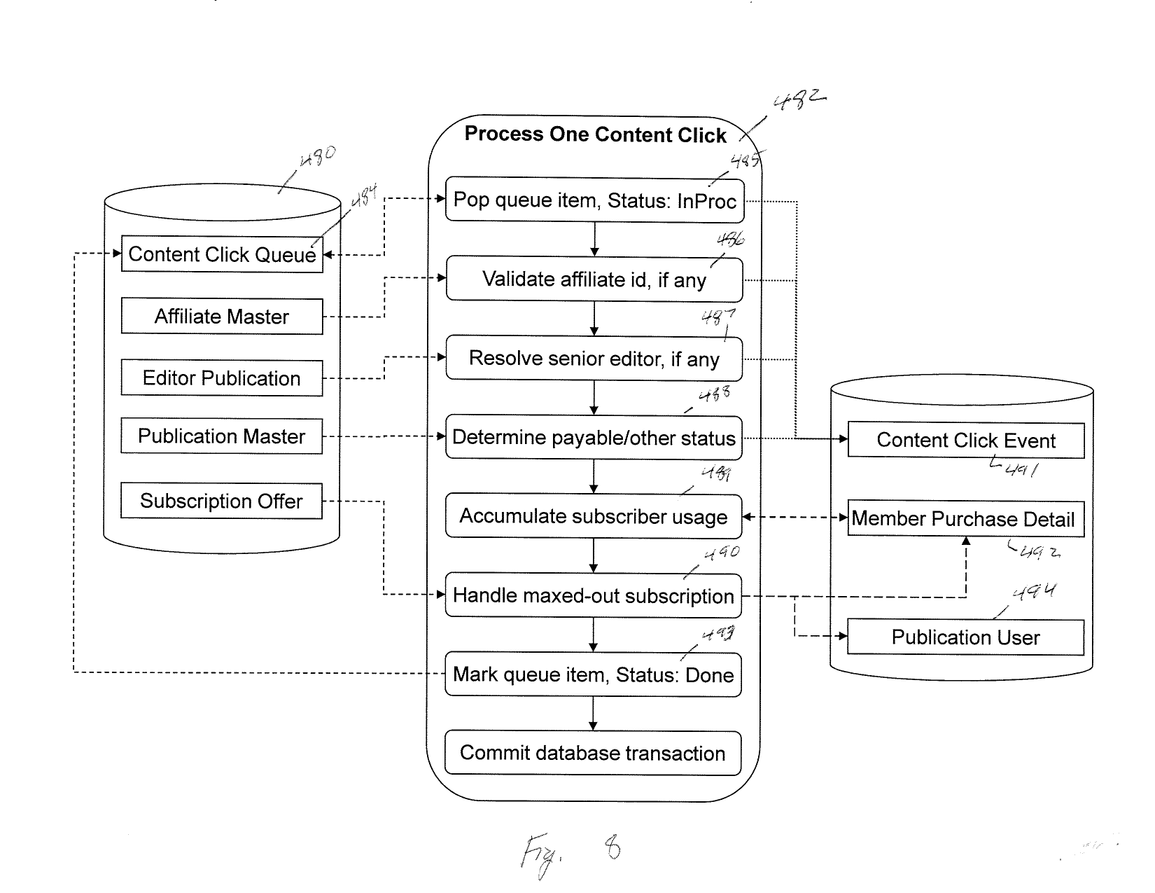

As shown in FIG. 8, the Add Content Click Engine supports the batch processing service (job) run for picking up the queued content clicks, adding them as ClickEvents, and adjusting the statistics in the associated MemberPurchaseDetail records. This includes resolving the affiliate and senior editor and determining whether the subscription has maxed out.

The multithreaded batch processing of the Add Content Click Engine 482 supports rigorous transactional recovery after a restart in the event of failure. Content click queue 484 represents the collection of work to be done under multiple transactions and not necessarily in any particular order. If the job of doing the work in the content click queue 484 is interrupted, it is typically guaranteed that upon recovery the remaining work will get done, and any work that is repeated is harmless. Fine-grained transactions allow for a high degree of concurrent, distributed processing with minimal contention and typically guaranteed recoverability.

The Add Content Click Engine Batch Service 482 receives ContentClickQ and ContentClickIn records from content click queue 484 and processes them. PaidClicks are determined (see 488). SeniorEditor (if any) is determined (see 487). Affiliate ID or code (if any) is validated (see 486). This is multithreaded, with a cleanup job for crash recovery. Recoverability is intended to be guaranteed.
AddContentClickEngine is part of Distributed Batch Processing Services (CGBDLL*.d11)
CGBClsBatAddContentClickEngine.cs in CGBDLLS.dll, adds click data to the database
Built by \CG_CMP\Util\CGBDLL\CGBDLL.sln
C# batch function (BatAddContentClickEngine) is run by the CMPlAddContentClickEngine job

The Add Content Click Engine Batch Job can be summarized as follows:

The AddContentClickEngine function supports a multithreaded batch service. Each thread handles one content click at a time. There can be multiple instances of this engine on a single computer or on multiple computers (application servers), and all of these processes can be popping items from the content click queue simultaneously. Every content click item is typically guaranteed to be picked up by one and only one processing thread, which does the following:
Pops a Content Click queue item (see 485) from content click queue 484, which puts the item into “InProcess” status and commits it, making it recoverable
Validates affiliate if any and determines senior editor, if any (see 486 and 487)
Determines if PaidClick or other (CancelOrFailClick, RepeatClick) status of subscriber click. If this click is a NonSubscriberClick, this has already been determined by the web application (prior to writing the web log record used to construct the ContentClickln record). See 488
Updates subscription usage statistics in the MemberPurchaseDetail record in memory. See 489, 492
Handles maxed out subscription (MemberPurchaseDetail and Publication User records) in memory. See 490, 494
Adds ContentClickEvent without committing transaction. If duplicate, rolls back work. See 491
Calls MarkDbQItmAsDone, which commits the INSERT and UPDATE operations as a single transaction. See 493
Deletes the corresponding ContentClickQ record.

Additionally, BatEntityPaymentDetailPurchaseEngine is a batch service that walks through approved MemberPurchaseTran records in approximate date-time order and creates and then continuously updates EntityPaymentDetail records. These collect for the day the amount owed each involved entity that is paid based on a division of subscription sales (and not on subscriber usage). The EntityPaymentDetail records for the current day are repeatedly updated as the day progresses with payments due to publishers, affiliates who have made subscription sales, sales tax entities, the CMP Service Fee entity, the credit card processor (financial service), and the Compensation Pool Reserve entity. The Entity Payment Detail Purchase Engine batch service transforms the Member Purchase Transaction Records into Entity Payment Detail Records. The Entity Payment Detail Purchase Engine batch service further loops through approved MemberPurchaseTran records in date/time order, creating or updating EntityPaymentDetail records, Cleanup for BatEntityPaymentDetail-PurchaseEngine is not needed for recovery, because processing of each MemberPurchaseTran record is done as a single transaction.

A MemberPurchaseTran record can represent one or more subscription purchases to one or more publications (channels). The EntityPaymentDetailPurchaseEngine loops through Member Purchase Transaction records that are in “Approved” status and processes the associated Member Purchase Detail records, each of which represents the purchase of one subscription. The Engine rolls up the money each entity makes from all subscription sales for the given day and publication (as a single transaction). As the last step of processing a purchase, the MemberPurchaseTran record has its status changed from “Approved” to “Accounting initiated”.

The EntityUsageAmount field of Entity Payment Detail records accumulates the payment shares (fractional transaction amount for this entity) and these are updated with the appropriate percent of the purchase price according to the MemberPurchaseDetail record. With the exception of the credit card processing fee, the EntityUsageAmount is an actual dollar payment amount and not an estimated amount. This amount can be updated as soon as a subscription sale is approved by the credit card processor (although actual payments are delayed for some period, such as 30 days, to cover a money-back guarantee).

Member Purchase Transaction processing is ordered by PaymentTranDate and PaymentTranTime (when Approved). PaymentTranDate is the date approved by the payment processor (financial service entity) and can be different from ClickDate (e.g. for “Error needs review”). Similarly, PaymentTranTime and ClickTime can be different if this purchase was done as part of a ContentClickEvent. Since users can purchase directly from the CMP Service web site, subscription sales are not necessarily associated with a particular ContentClick-Event.

Every time the PurchaseEntityPaymentDetailEngine loops through looking for Active purchases, it starts with the earliest one found and proceeds chronologically, regardless of where it started or stopped on the last loop. Because the complete processing of a Member Purchase Transaction is done as a single database transaction, the exact order that they are picked up by the PurchaseEntityPaymentDetailEngine is not critical. No lag time needs to be used to delay picking up purchases as they happen, because there is no harm in minor clock/network delays caused by different web servers creating these records. Once a Member Purchase Transaction is “Approved”, the Engine can process it immediately, and as soon as processing is done its status is changed to “Accounting initiated”, and it is no longer eligible to be picked up by this Engine.

The PurchaseEntityPaymentDetailEngine is single-threaded and handles one MemberPurchaseTransaction record at a time. This reduces the potential for deadlock and slow speed that would be caused by this background process interfering with end-user credit card purchases. It's more important to protect the web site performance than to allocate the subscription sale amount to the various parties as quickly as possible.

This transaction processing model simplifies recovery and should be adequate until the rate of subscription purchases gets very high. Cancelling a job or recovering from a failure requires no special processing because the database transaction processing guarantees that a Member Purchase Transaction is either completely processed or not. However, since there is the potential of multiple publications being purchased simultaneously and the number of records involved can grow, the processing is done to minimize locking. (Most often, there will be only one MemberPurchaseDetail record.)

The processing of a member purchase transaction can be broken down into three steps:
1. Create any missing EntityPaymentDetail records and resolve identity of affiliate, if any:
   Run through all MemberPurchaseDetail records for this MemberPurchaseTran. In this run create EntityPaymentDetail records in memory and resolve the AffiliateEntityCodOrId. If there is any affiliate, commit each MemberPurchaseDetail individually after doing the affiliate lookup.
   Resolve AffiliateEntityCodOrId if supplied as ContentURL parameter or parameter sent by an affiliate to a CGWeb page. The AffiliateEntityCodOrId in each of the MemberPurchaseDetail records is typically always the same as the MemberPurchaseTran record (if the AffiliateEntityCodOrId is present).
      Uses same function as affiliate processing that AddContentClickEngine does for a ContentClickEvent
      Determine AffiliateEntityCod from AffiliateEntityCodOrId
      If AffiliateEntityCod is found, set the AffiliateEntityCod field of the MemberPurchaseDetail
      If no valid affiliate found,
         Set the BadAffiliateEntityCodOrId field, and leave AffiliateEntityCod as null
         The EntityPaymentDetail record will be updated for the CMP Service Bad Affiliate Entity
   Make an initial check to make sure that all EntityPaymentDetail records needed for this MemberPurchaseTran are present. If any are missing, add each individually, as SEPARATE transactions. (This means that all EntityPaymentDetail records come into being initially with a zero EntityUsageAmount, which is then updated repeatedly as the MemberPurchaseTran records are processed.)
2. Update the individual EntityPaymentDetail records without commit.
   The MemberPurchaseDetail record always has a PublisherEntityCod, and the associated PurchaseShareAmountPublisher is credited to that entity's EntityPaymentDetail record with a Payment Transaction Type of “Subscription sales to publisher” for that publication, entity code, and transaction date.
   If there is an Affiliate Entity Code, credit the associated PurchaseShareAmountWebSiteAffilate to that affiliate entity with a Payment Transaction Type of “Subscription sales to affiliate” for that publication and date. If there is a BadAffiliateCodOrId, the PurchaseShareAmountWebSiteAffiliate is credited to the CMP Service Bad Affiliate Entity (as opposed to an actual affiliate) with a Payment Transaction Type of “Bad affiliate sales to CMP service fee”.
   If there is Sales Tax, it will have a TaxAmount, and it is credited to the appropriate government agency with a Payment Transaction Type of “Subscription sales tax to State” for that publication and date.
   The credit card charges in PurchaseShareAmountFinancialService are credited to the appropriate financial service with Payment Transaction Type of “Subscription sales to payment processor” for that publication and date.
   The PurchaseShareAmountCMPService is credited to the CMP Service Fee Entity with a Payment Transaction Type of “Subscription sales to CMP service fee” for that publication and date.
   The PurchaseShareAmountCompensationPool is credited to the Compensation Pool Reserve entity with a Payment Transaction Type of “Subscription sales to compensation pool” for that publication and date. (The resulting EntityPaymentDetail record has the amount put into the publication's compensation pool from the day's subscription sales.)
3. Finally, the Member Purchase Transaction Status Code is changed from “Approved” to “Accounting initiated” and the entire transaction is committed. The change typically is the only update that affects an index, and it's an update that can conflict with synchronous web site modifications, so it's saved for last.

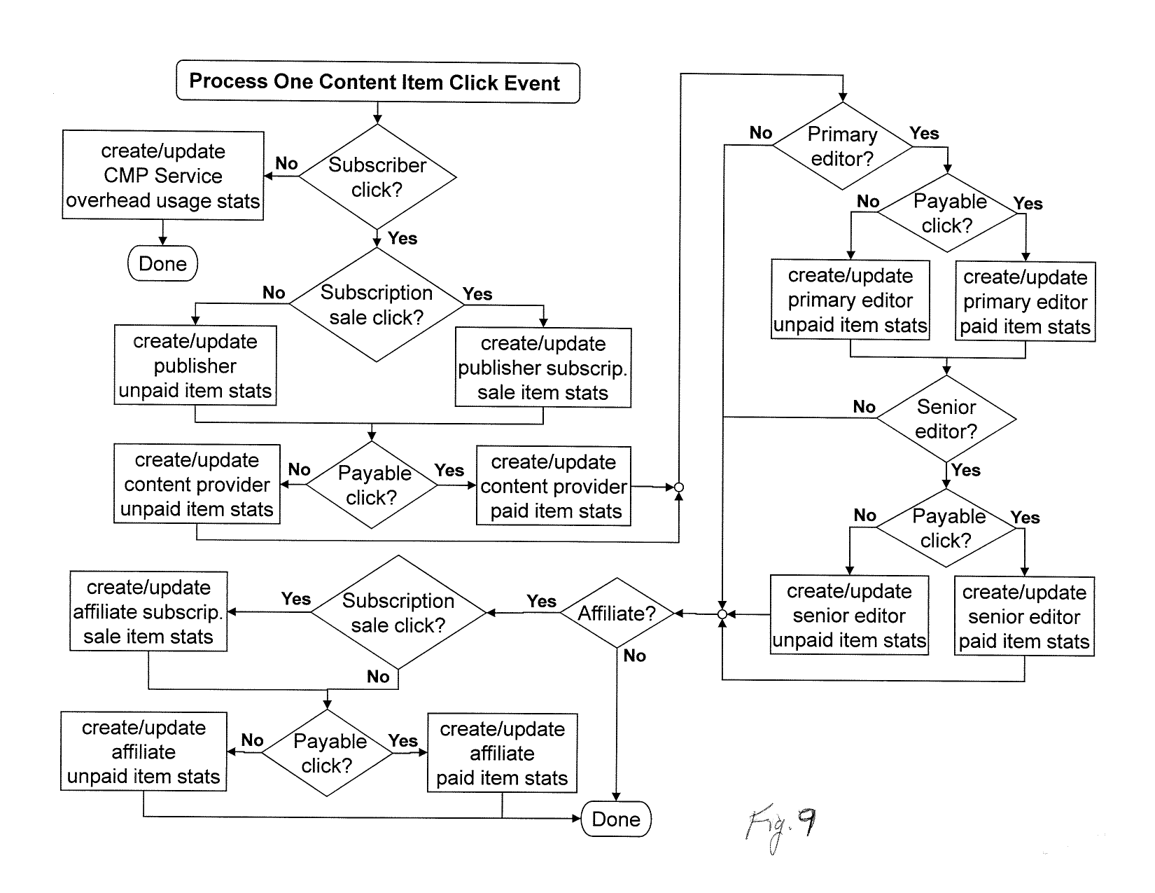

As shown in FIG. 9, the CollectEntityContentItmUsage batch service processes through ContentClickEvent records, one publication at a time in ClickDate and ClickTime order, and creates and then continuously updates EntityContentItmUsage records, which collect each ClickDate's usage statistics for each involved entity.

CollectEntityContentItmUsage rolls up the daily ContentClickEvent usage data by ClickDate, content item, and distinct URLRemParamStr returned for a given content click on that ClickDate. Also, if the ownership of the publication has changed for the publication at some point during a ClickDate, there are separate EntityContentItmUsage records for the period of the day that each publisher owned the publication.

This batch function makes one complete loop through all publications that have had any activity in the date-time range being considered. It walks through ContentClickEvents in Publication, ClickDate, ClickTime order. When the job starts, a list is created of all publication codes with ContentClickEvents greater than the LastEndClickDate and Time (with PublicationCod>0 to encourage index scan) in PublicationCod order. For each publication, ContentClickEvent records are processed starting from (greater than) the LastEndClickDate and LastEndClickTime to a new ending ClickDate and Time that is set at the beginning of the complete loop through the publications. The writing of EntityContentItmUsage records for each publication can be handled by a different thread.

If the LastEndClickTime is exactly 00:00:00, then a special adjustment must be made to the LastEndClickDate and Time. That is, the LastEndClickDate should be reduced by one day, and the LastEndClickTime should be 23.59.59.999999 (internally), so that the ContentClickEvents that have a time of 00:00:00 are not skipped over by the greater-than date-time comparison logic.

The publication loop uses the current value of the LastEndClickDate and LastEndClickTime as its start value for all publications being looped through. The ending date/time value for the loop is some minutes before the current time, and this is also held constant for all publications during a single run of this job. By stopping the processing some minutes before “now”, a lag is created that typically guarantees there's a buffer for late arrivals and clock errors, and more importantly, that the log file buffer has been flushed to disk. Thus there is both a constant starting and ending value that is used for all publications until the next time the job is run, which then starts from new LastEndClickDate and LastEndClickTime. The ending lag before “now” is a program constant, CLICK_TimeLagSecondCt, e.g. 1800, one-half hour for production or less for testing and demo. If the newly calculated LastEndClickTime is exactly 00:00:00, then this date-time must be reduced by one second to the previous day's 23:59:59. This prevents the possibility of skipping over any 00:00:00 ContentClickEvents because a Cleanup job needed to be run.

At the end of the CollectEntityContentItmUsage job, which has looped through any events for all the publications, the LastEndClickDate and Time becomes the new ContentClickEvent range start value. The new LastEndClickDate and Time values are written to the Batch Parameter String of the associated batch job record. Thus, the LastEndClickDate and Time act as a progress indicator and a syncpoint.

As it loops through the ContentClickEvent range for each publication, the engine continuously updates the ClickDate's usage statistics for each related entity: publisher, content provider, editor, affiliate, and the CMP Service itself. It distributes each ContentClickEvent to the associated EntityContentItmUsage records for that ClickDate. It adds an EntityContentItmUsage record on the day's first usage of a given content and URL Remark Parameter.

The CollectEntityContentItmUsage job rolls up all usage data for the ContentClickEvents for all entities, but does not assign any financial amounts. Summarizing of actual money amounts to be distributed to the publisher, affiliate web site, content providers, editors, etc. is done elsewhere in the workflow (e.g. by the EntityPaymentDetailPurchaseEngine and the batch functions for dividing the compensation pool).

Every ContentClickEvent adds or changes an EntityContentItmUsage record for either the publisher or the CMP Service Overhead entity, depending on whether it is a subscriber or non-subscriber click (based on the Content Click Result Type Code). For a given content item, ClickDate, and URL Remark, every subscriber click is accumulated into one of two EntityContentItmUsage records for the publisher. One record is for clicks that caused a subscription sale (with Payment Transaction Type of “Subscription sales to publisher”). The other is for all other clicks by any subscriber (with Payment Transaction Type Code of zero). That is, if no sale was made to a subscriber in connection with a particular click, then no money is due the publisher, and the Payment Transaction Type is a logical null.

For a given content item, URL Remark, and ClickDate, every non-subscriber click is put into a single record for the CMP Service. This has a Payment Transaction Type Code of zero, and represents overhead borne by the CMP Service, for example to allow CMP and publisher staff to access content without requiring subscriptions. Unexpectedly high numbers here may indicate that administrative User IDs are being misused. A special entity code is reserved to track this overhead (CMP_ServiceOverheadEntityCod 51), which is distinct from the usual CMP Service code, because the CMP Service provider can also act as a publisher for some channel. Thus, for a NonSubscriber ContentClickEvent, only one EntityContentItmUsage is record created or modified (with NO record for the publisher or any other entity).

Only a publisher and the CMP Service are required to be involved in any particular ContentClickEvent. A content provider, editor, or affiliate may or may not be associated with a ContentClickEvent. Occasionally, a publisher may choose to be the content provider or editor for some of his publication's content items (but he cannot be an affiliate for his own publication), and this has no effect on the algorithm for creating and updating EntityContentItmUsage records.

For a given content item, URL Remark, and ClickDate, every subscriber click that specifies a content provider is put into one of two EntityContentItmUsage records for that content provider. One record is for paid clicks (with Payment Transaction Type of “Paid usage to content provider”). The other is for all unpaid clicks (e.g. RepeatClicks, CancelOrFailClicks) by any subscriber (with Payment Transaction Type Code of zero).

A content item may have up to two editors (a primary editor and a senior editor), and these have associated EntityContentItmUsage records for the given content item, Click Date, and Content URL Remark. Paid clicks that specify a primary editor are accumulated with the Payment Transaction Type of “Paid usage to primary editor” and those that specify a senior editor are accumulated under “Paid usage to senior editor”. Unpaid clicks (e.g. RepeatClicks, CancelOrFailClicks) are all assigned a Payment Transaction Type Code of zero for each type of editor. For unpaid usage, there is tracking of the clicks for each entity involved, but no attempt is made to subdivide by entity role.

Web site affiliates make money two different ways: by selling subscriptions and by referring subscribers to content. Either or both can happen as a result of a ContentClickEvent, and each has its own Payment Transaction Type and therefore EntityContentItmUsage record. A subscription can be sold (which is given a Payment Transaction Type of “Subscription sale to affiliate”) at the same time as the content is served (which is given a Payment Transaction Type of “Paid usage to affiliate”). On the other hand, the subscription sale can succeed but the content delivery can fail, or the content delivery may be for a previously purchased subscription. (If the subscription has been bought without there being an associated ContentClickEvent for some particular content item, then the subscription sale is accounted for, but typically never appears in any EntityContentItmUsage record.) Besides the two forms of affiliate remuneration, if this is an unpaid subscriber click, i.e. no payment is due the affiliate (because of RepeatClick or CancelOrFailClick), then the Payment Transaction Type Code is set to zero in the EntityContentItmUsage record used to accumulate the affiliate's results.

Adding a new EntityContentItmUsage record is typically always done first, as an independent transaction, i.e. separately from incrementing the full set of usage statistics across multiple records. This allows ContentClickEvent usage data to be added to EntityContentItmUsage through ChgRec (UPDATE) operations, as opposed to using less efficient AddRec (INSERT) operations, which would require a longer duration of index locking. If a crash occurs, it is Ok for a EntityContentItmUsage record to be present for a date and show NO usage yet.

The Cleanup job for CollectEntityContentItmUsage handles hard failures (crashes) simply by deleting every EntityContentItmUsage record for the LastEndClickDate (from the Batch Job Parameter String of the failed job) until now. Then, the engine finds the parent batch job record and resets the LastEndClickDate and Time to the Batch Parameter's LastEndClickDate and 00:00:00, so that a greater-than or equal to date comparison can be used for cleanup (instead of the usual job's greater-than date-time comparison). Cleanup loops through publications and deletes in bulk (through CMP's ScrollCache facility).

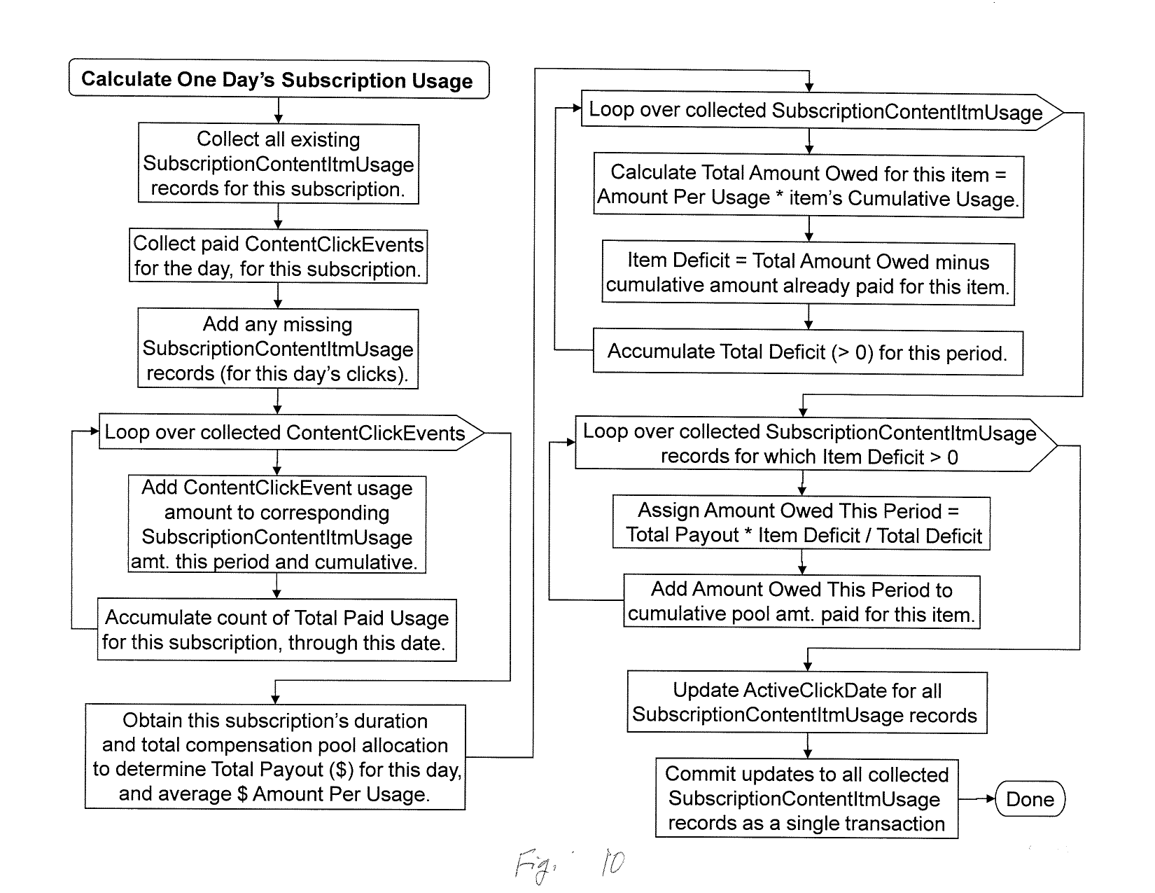

As shown in FIG. 10, the income from subscriptions that comes from the compensation pool is spread out over the life of the subscription. The CalcSubscriptionUsage batch function creates and then updates SubscriptionContentItmUsage records, which provide a detailed breakdown of the total paid usage by a subscriber over the life of his subscription. The subscriber's usage to date is used in calculating the price to be assigned on the ActiveClickDate to a PaidClick by the given subscriber. For a given subscription, there is a distinct SubscriptionContentItmUsage record for each combination of content item, web site affiliate, editor, and URL Remark (e.g. to specify the page or page version that the user clicked), summarizing the set of all ContentClickEvents associated with that subscription. Each SubscriptionContentItmUsage record ends up with the actual dollar value to distribute for the ActiveClickDate and the underlying usage statistics for calculating those dollar values.

The CalcSubscriptionUsage process loops through candidate MemberPurchaseDetail records and the day's paid ContentClickEvents and accumulates usage in the SubscriptionContentItmUsage records and processes them to calculate their day and cumulative CompensationPool-Amounts. This job typically must run after AddContentClickEngine and EntityPayment-DetailPurchase have finished processing the ActiveClickDate, and it must run before Collect-EntityContentItmUsageAmount can start processing the ActiveClickDate. The job can safely be run automatically on a daily basis, e.g. about an hour after midnight. Typically, a separate cleanup job is not required for CalcSubscriptionUsage because the process typically always checks that ActiveClickDate is LastEndActiveClickDate or skips the subscription. For recovery, the process starts over from the day after the LastEndActiveClickDate and ignores MemberPurchaseDetail records already processed (which can be determined from SubscriptionContentItmUsage records' state), and then it picks up from where processing left off and continues. The ActiveClickDate in the record is used to decide whether to skip over it because it's already done. Account closing is done one ActiveClickDate (processing date) at a time, and the CalcSubscriptionUsage batch job starts the closing process for the previous day. It loops through MemberPurchaseDetail records that are relevant for this accounting period (ActiveClickDate), and for each active subscription loops through the day's paid ContentClickEvents, accumulating usage statistics and compensation pool payments in the SubscriptionContentItmUsage records.

The CalcSubscriptionUsage function reads and processes each MemberPurchaseDetail record for qualifying subscriptions (between SubscriptionStartDate and SubscriptionEndDate inclusive) in publication, SubscriptionStartDate order. For each MemberPurchaseDetail record retrieved, CalcSubscriptionUsage looks for and processes any associated ContentClickEvent records for the current ActiveClickDate. SubscriptionContentItmUsage records are added if this is the first instance of this subscription and combination of content, editor, affiliate, and URL Remark parameter. Each paid ContentClickEvent causes a single SubscriptionContentItmUsage record to be updated.

The following is the sequence of fields in the MemberPurchaseDetail index that is used for walking through the records that were in effect for the accounting period, i.e. the job's ActiveClickDate:
PublicationCod, SubscriptionStartDate, SubscriptionEndDate, UsrCod, MemberPurchaseTranCod, MemberPurchaseDetailCod

Ideally, the CalcSubscriptionUsage job runs once per day, after midnight (close) of ClickDate (“ActiveClickDate” for account processing). It starts some minutes late to get credit card payment gateway responses to last purchases of day and, more importantly, to typically guarantee that the web logs for determining Content Click Events have been flushed to disk.

CalcSubscriptionUsage is a multithreaded job that is assumed to run on a single batch machine. There is one reader thread for looping through the MemberPurchaseDetail records and multiple writer threads for creating and updating the SubscriptionContentItmUsage records. (To employ multiple batch machines, the processing would need to be done by partitioning the publications, so that no two machines process the same publication at the same time.) As currently implemented, all MemberPurchaseDetail records are picked up by one machine, and the single reader thread typically guarantees that no two writer threads pick up the same subscription. (One possible enhancement to increase scalability: Because the reader's job is just to pick up the MemberPurchaseDetail records, it can be suspended regularly when some number of records have accumulated for the writers to process, so that a limited number of MemberPurchaseDetail records are held in memory at the same time.)

The CalcSubscriptionUsage job is typically run for only one ActiveClickDate at a time, which is the day following the LastEndActiveClickDate supplied in the Batch Parameter String. At the start of this job, the LastEndActiveClickDate parameter, if any, is read and incremented in memory to the next calendar day to become the Current ActiveClickDate for this job. If no LastEndActiveClickDate parameter is present, then the minimum SubscriptionStartDate of all of the MemberPurchaseDetail records minus one day is used as the LastEndActiveClickDate. This simplifies repeated runs against canned test data.

The LastEndActiveClickDate and CurActiveClickData typically cannot be today, because the day's accounting cannot be closed until after midnight and the flushing to disk of the web logs. If the LastEndActiveClickDate or CurActiveClickDate is more recent then yesterday, then CalcSubscriptionUsage returns a Batch Completion Code of COMPLET_ActiveClickDateTooRecent.

For a given publication's recoverability, processing of ContentClickEvents for the next ActiveClickDate cannot begin until the accounting has been done on all of that publication's SubscriptionContentItmUsage records and all of the subsequent accounting rollup jobs have executed successfully. For simplification of operations, all publications are closed together by CalcSubscriptionUsage, so before processing the next ActiveClickDate, the next job in the accounting series (CollectEntityContentItmUsageAmount) must also be through processing the current ActiveClickDate.

Note that for a given user and publication, there can typically be more than one MemberPurchaseDetail record that applies for a given publication, user, and ActiveClickDate, but these records are processed independently. This can happen on the day a subscription's maximum usage has been reached. However, at any given moment of any ClickDate, there is typically only one “active” subscription, i.e. MemberPurchaseDetail record. (Since only PaidClicks are considered, every SubscriptionContentItmUsage record has a non-null MemberPurchaseTranCod and MemberPurchaseDetailCod.)

Typically only MemberPurchaseDetail records that have Subscription Status of “Active”, “Maxed out”, or “Expired”, and whose range of subscription dates includes the ActiveClickDate are processed. For each subscription (MemberPurchasDetail record) processed, CalcSubscriptionUsage retrieves the PAID ContentClickEvents for the current ActiveClickDate, accumulates usage in the SubscriptionContentItmUsage records, and calculates their day and cumulative CompensationPoolAmounts. For efficiency, any needed SubscriptionContentItmUsage records are each added as separate transactions before any other work is done on the subscription. The buckets (accumulators) collected from the ContentClickEvents are PaidStreamDurationSecondsThisPeriod, PaidDownloadCtThisPeriod, and PaidDownloadByteCtThisPeriod.

Once the day's ContentClickEvents have been picked up, the next step in processing a MemberPurchaseDetail record is calculating the new values of the CompensationPoolAmountThisPeriod (i.e. for the current ActiveClickDate) for each SubscriptionContentItmUsage record for this subscription. The amount of the MemberPurchaseDetail's compensation pool to be distributed for this ActiveClickDate is calculated for every SubscriptionContentItmUsage record associated with this subscription, including items only used prior to the ActiveClickDate during this subscription.

New cumulative values are calculated for all the associated SubscriptionContentItmUsage records, specifically the CompensationPoolAmount-Cumulative, PaidStreamDurationSecondsCumulative, PaidDownloadCtCumulative, and PaidDownloadByteCtCumulative. At the same time the ActiveClickDate in the records are incremented one calendar day so that it becomes the new value for the SubscriptionContentItmUsage records associated with this subscription and all the cumulative values contain today's values. These changes to the SubscriptionContentItmUsage records associated with a single MemberPurchaseDetail record can then be applied quickly and efficiently committed as a single transaction.

Updates with the day's paid usage statistics and the calculated compensation pool amounts (i.e. since the previous day) are done as a single final transaction for the subscription. This final processing step involves committing updates on all the SubscriptionContentItmUsage records for the subscription, but none of the fields involved are indexed, and no other thread requires write access to any of these specific records. Given that the number of SubscriptionContentItmUsage records involved is unlikely to more than a few hundred, the locking required is unlikely to cause multi-processing bottlenecks or unacceptable performance.

A SubscriptionContentItmUsage record typically always has the CompensationPoolAmountThisPeriod as of the ActiveClickDate, and this is typically always included in the CompensationPoolAmountCumulative. That way, for recovery purposes, it is typically guaranteed safe to skip over SubscriptionContentItmUsage records having the current ActiveClickDate and assume that they were computed in a prior run that did not complete successfully in processing all the day's subscriptions.

For each active subscription (MemberPurchaseDetail record), the CalcSubscriptionUsage function:
1) Collects in memory all SubscriptionContentItmUsage records already created for this subscription
2) Collects paid ContentClickEvents for the day, if any
3) Creates any missing SubscriptionContentItmUsage records in the database
4) Adds the ContentClickEvent usage to the SubscriptionContentItmUsage records in memory
5) Calculates the money amounts to be distributed from compensation pool for this subscription and ClickDate

This final step of CalcSubscriptionUsage calculates the total CompensationPoolAmount to be distributed among the SubscriptionContentItmUsage records for this subscription on this date. The total CompensationPoolAmount to be divided over the life of a subscription is the PurchaseShareAmountCompensationPool in the MemberPurchaseDetail record. The pro-rated daily dollar amount is an exact figure for each particular subscription (and is NOT an average across multiple subscriptions). In order to support the precise sampling required for audit by content providers and affiliates while providing limited access to full publication data, it is necessary to perform rigorous calculation for each and every subscription.

In determining the CompensationPoolAmount to be distributed on this ActiveClickDate, once there have been any content clicks by the subscriber, some amount of the compensation pool is distributed each day for this subscription, whether or not there were any paid clicks on that particular day. In the unusual event that a subscription has been bought but there has been no activity, there will be a MemberPurchaseDetail record but no ContentClickEvent or SubscriptionContentItmUsage records. If and when there are finally some content clicks by the user, SubscriptionContentItmUsage records are created, with multiple days' worth of the subscription's CompensationPoolAmount being distributed. If no ContentClicks exist for a subscription at the end of the subscription, no portion of its contribution to the compensation pool gets distributed, and this amount is instead credited to the CMP Service. (The CMP Service absorbs rounding errors, unpaid usage, and other processing cost, etc.)

On a given day, the CompensationPoolAmount to be distributed among the SubscriptionContentItmUsage records associated with a subscription that is a candidate for processing typically follows these rules:
1. If subscription status is “Waiting” or “Declined or error” OR it is “Active” or “Expired” and there have been no ContentClickEvents since the subscription started, then the subscription is skipped, with no money distributed.
2. If the subscription status is “Active”, “Maxed out”, or “Expired” and this ActiveClickDate is the first one with ContentClickEvents for this subscription (i.e. no SubscriptionContentItmUsage records existed at the start of this job run), then use the pro-rated daily amount (i.e. PurchaseShareAmountCompensationPool divided by the length of the subscription) times the number of days since the start of the subscription period, including the day it started. (Most often the first use of a subscription will take place on the first day.)
3. If subscription status is “Active” or “Expired” on this Active ClickDate and this is NOT the first day with ContentClickEvents for this subscription, then use the pro-rated daily amount, i.e. PurchaseShareAmountCompensationPool divided by the length of the subscription.
4. If the subscription status is “Maxed out”, then include the pro-rated daily amount for any unused subscription period left over plus this day (because the subscription may be maxed out before it had a chance to expire)
   CalcSubscriptionUsage computes a “deficit” money amount for each of the SubscriptionContentItmUsage records for this day for this subscription. The deficit is the difference between the “ideal” amount for the actual usage to date and the actual amount paid to date for a particular item of content. This computation entails the following calculation steps:
Get the duration of subscription in days.
Amount to be paid per day=Total Compensation Pool Amount/Total Days.
Subscription usage in days till date (i.e. days elapsed from start of subscription)=current ClickDate being processed−Subscription Start Date+1
Amount to be distributed to date=Amount per Day*Subscription Usage Day Count.
Amount Per Usage=Amount to be distributed till date/Total Cumulative Usage Count to date.
For each SubscriptionContentItmUsage record in memory
   Amount owed for this SubscriptionContentItmUsage record=Amount Per Usage*Cumulative Usage Count
   Deficit Amount for this record=Amount owed−CompensationPoolAmountCumulative (i.e. amount paid to date)
   Store this deficit amount for each of the records in memory, and accumulate the total of all deficits>0
      After the preceding determination of deficit amounts, CalcSubscriptionUsage distributes the day's allocation of compensation pool money among the subscription's SubscriptionContentItmUsage records in such a way as to closely approximate the ideal “fair” distribution, where compensation for each item used is proportional to its relative usage over the entire life of the subscription.

CalcSubscriptionUsage adds non-zero amounts to the CompensationPoolAmountThisPeriod field of one or more SubscriptionContentItmUsage records in memory. It also adds the day's usage, if any, into the cumulative usage fields, and updates the cumulative amount field in the affected SubscriptionContentItmUsage records to include the latest ActiveClickDate's Compensation-PoolAmount. The compensation pool distribution percentages are derived from the SubscriptionContentItmUsage deficit amounts, obtaining values of CompensationPoolPercentThisPeriod. This is the percentage of the day's compensation pool allocation to be awarded for this SubscriptionContentItmUsage record (combination of content item, editor(s), web site affiliate, and URL Remark parameter), for this ActiveClickDate.

For a given subscription, the sum of the CompensationPoolPercentThisPeriod field for all the day's SubscriptionContentItmUsage records must be equal to 100%. Even when there is no paid activity for this period (day), the CompensationPoolPercentThisPeriod is not necessarily zero. This value is adjusted so that the actual amount disbursed for the references (paid ContentClickEvents) represented by this record approaches the idealized amount as the subscription progresses over time. The idea is that, for each subscription, the distribution of content items referenced (in percentage) going back to the beginning of that subscription is identical to the distribution of amounts disbursed for those content items. Achieving this ideal distribution is a non-trivial problem, because non-refundable, incremental compensation is assumed to have been made during the course of each subscription, not deferred to the end of the subscription (which might typically span an entire year). The ability to make such incremental payouts, for example on a monthly basis, is an important advantage of the system's design, because it contributes greatly to its credibility and trustworthiness.

The CompensationPoolPercentThisPeriod is used to provide a normalized distribution of content items (and variant forms of references to this content), and this is used in allocating credit and therefore payments for each subscription. In practice, some greater weight typically is given to the early PaidClicks, in the event of a residual imbalance. This is appropriate given that the early clicks presumably reflect the user's primary reason for purchasing the subscription, i.e. bias is created in the right direction.

CompensationPoolPercentThisPeriod can be arrived at by using the ratio of the deficit amount for the current SubscriptionContentItmUsage record over the total deficit amount. The total deficit is the sum of all non-negative item deficits, i.e. the total allocation that would be needed to fairly compensate those items that have been under-compensated. A negative item deficit indicates an item that has been over-compensated, taking into account all subscription usage to date. Since payments already disbursed are not refundable, the best that can be done for over-compensated items is to award them nothing more in this accounting period. For items that have been under-compensated (i.e. having deficit>0), the best that can be done is to split this accounting period's compensation pool allocation among them, in proportion to their current deficits.

For each of the records in memory, CalcSubscriptionUsage distributes the compensation pool amount available this period according to the deficit amount noted in each of the collected SubscriptionContentItmUsage records in memory, considering only those whose deficit amount is greater than zero.
Calculate AmountOwedThisPeriod (i.e. for this item)=AmountToBePaidThisPeriod (i.e. for the subscription as a whole)*DeficitAmount (i.e. item deficit)/TotalDeficitAmount (i.e. total deficit for the subscription)
Store AmountOwedThisPeriod in the record and add this AmountOwedThisPeriod to the existing value of CompensationPoolAmountCumulative.
   Upon completion of the preceding loop over SubscriptionContentItmUsage records with deficit>0, the final steps in calculating one day's worth of usage for a given subscription are these:
Increment the ActiveClickDate from the LastEndActiveClickDate to the current ActiveClickDate for the collected SubscriptionContentItmUsage records
Perform the update (ChgRec) on all collected SubscriptionContentItmUsage records as a single transaction. This is done as multiple ChgRec operations using the previously obtained LastMod keys and a single Commit only on the final record. There is no need for a second retrieval (GetRec) for any of the SubscriptionContentItmUsage records, because no other process is touching these same records.

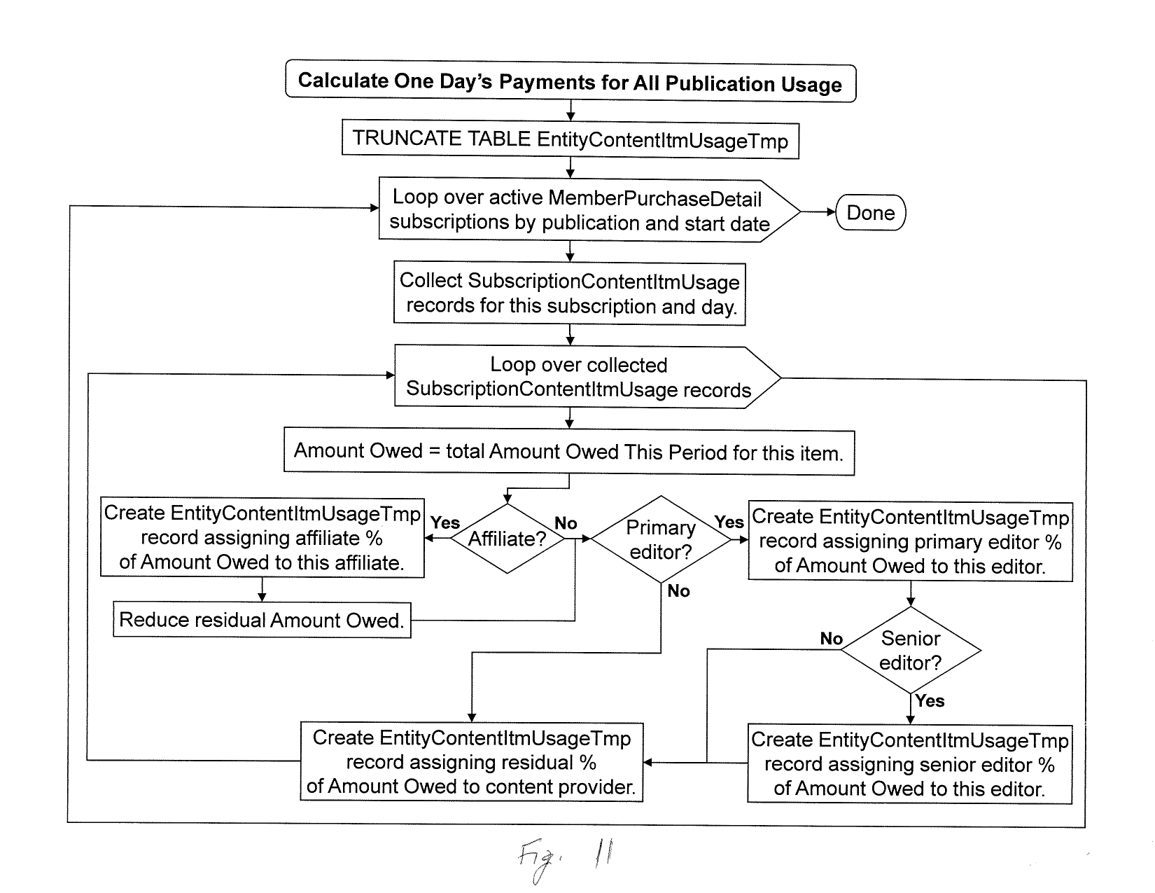

As shown in FIG. 11, the payments are apportioned for daily use by item, payee, and payment amount. CollectEntityContentItmUsageAmount is the batch processing service (job) that splits up the day's compensation pool amounts in the SubscriptionContentItmUsage records into a temporary table. The function generates EntityContentItmUsageTmp records that temporarily hold the compensation pool amounts for usage payments to the channel's content providers, editors, and web site affiliates. This step is part of closing the day's accounting and is done by processing the MemberPurchaseDetail records in effect on the ActiveClickDate and collecting the compensation pool amounts in the associated SubscriptionContentItmUsage records. (The use of EntityContentItmUsageTmp temporary records is an optimization that avoids the need for costly sorts in the final rollup of EntityContentItmUsage records and allows for efficient addition of any EntityContentItmUsage records not already created prior to closing the day's accounting.)

Account closing is done one ActiveClickDate (processing date) at a time, and the CollectEntityContentItmUsageAmount batch job is an intermediate step in the closing process for the previous day. It loops through the MemberPurchaseDetail records that are relevant for this accounting period (ActiveClickDate) and all of the associated SubscriptionContentItmUsage records. The function divides up and accumulates compensation pool payments (EntityContentItmUsageAmount) for each subscription into new EntityContentItmUsageTmp records.

In most embodiments, typically, the job runs once per day, after midnight (close) of ClickDate (“ActiveClickDate” for account processing). It can start immediately after the Calculate Subscription Usage batch job for the day (yesterday) has completed. The job is run for typically only one ActiveClickDate at a time, which is the day following the LastEndActiveClickDate supplied in the Batch Parameter String. At the start of this job, the LastEndActiveClickDate parameter, if any, is read and incremented in memory to the next calendar day to become the Current ActiveClickDate for this job. If NO LastEndActiveClickDate parameter is present, then the minimum SubscriptionStartDate of all of the MemberPurchaseDetail records minus one day is used as the LastEndActiveClickDate. This simplifies repeated runs against canned test data. If the CurActiveClickDate is more recent then yesterday, then CollectEntityContentItmUsageAmount returns a Batch Completion Code of COMPLET_ActiveClickDateTooRecent.

The CollectEntityContentItmUsageAmount function starts by executing a TRUNCATE TABLE statement to delete all the EntityContentItmUsageTmp records. Then, the main reader loop runs through the candidate MemberPurchaseDetail records and the writer threads process all of the associated SubscriptionContentItmUsage records for each subscription, collecting the CompensationPoolAmountThisPeriod, calculating the division between entities, and recording it in EntityContentItmUsageAmount fields. For each subscription, a check is made on the ActiveClickDate of the first SubscriptionContentItmUsage record to ensure that the date is the same as the current ActiveClickDate being processed. If the dates are different, CollectEntityContentItmUsageAmount returns Batch Completion Codes of either COMPLET_SubscriptionActiveClickDateTooRecent or COMPLET_SubscriptionActive-ClickDateTooOld (i.e. comparing the SubscriptionContentItmUsage record's ActiveClickDate to the Current ActiveClickDate).

The following is the list of fields in the MemberPurchaseDetail index that the reader thread uses for its loop, which walks through the subscriptions that were in effect for the ActiveClickDate (to divide up the work to be done by the writer threads):
PublicationCod, SubscriptionStartDate, SubscriptionEndDate, UsrCod, MemberPurchaseTranCod, MemberPurchaseDetailCod.

CollectEntityContentItmUsage is a multithreaded job that is assumed to run on a single batch machine. There is one reader thread for looping through the MemberPurchaseDetail records and multiple writer threads for creating the EntityContentItmUsageTmp records with the EntityContentItmUsageAmount.

The first step a writer does is to collect in virtual memory all the SubscriptionContentItmUsage records associated with the given MemberPurchaseDetail record. For each SubscriptionContentItmUsage record, the writer creates at least one and at most four EntityContentItmUsageTmp records.

The writer threads calculate how to divide up the day's individual SubscriptionContentItmUsage compensation pool amounts and allocate them in the EntityContentItmUsageAmount field of the EntityContentItmUsageTmp records, which do not yet exist. The record additions can be committed as the processing goes along, because recovery just involves deleting all the EntityContentItmUsageTmp records, which is done automatically on re-running.

Here are typical rules for dividing up the SubscriptionContentItm-UsageAmount of a SubscriptionContentItmUsage record into EntityContentItmUsageAmount fields:
1. The division of the UsageAmount is done according to the PublicationMast's “PoolPercentShare” fields for content provider, primary editor, and senior editor, PLUS a 20% share (FINANCE_AffiliateSharePercent) if affiliates are allowed for the publication. So, the PoolPercentShare fields in each PublicationMast record add up to 80% (assuming that affiliates are permitted).
2. SubscriptionContentItmUsage records typically only exists if there's paid usage, which requires a non-zero PoolPercentShareContentProvider. Therefore, every SubscriptionContentItmUsage record will result in the addition of at least one EntityContentItmUsageTmp record, with a Payment Transaction Type indicating that it is for the content provider.
3. There are also up to three additional EntityContentItmUsageTmp records that may be created for a SubscriptionContentItmUsage record, i.e. for usage payments to senior editor, primary editor, and/or affiliate.
4. If there is an affiliate, then it gets 20% of the UsageAmount (and any entities involved get 20% less than they would have without the affiliate).
5. If there is no senior editor or primary editor but there are non-zero PoolPercentShare fields in the PublicationMast for either or both, then the percentage that they would get is divided proportionally among the remaining entities (content provider and possibly editor and/or affiliate).

The following are some simple examples of dividing up the compensation pool UsageAmount. For the first example, assume the following percentage parameters for the channel:

Content provider gets 70%

Primary editor gets 20%

Senior editor gets 10%

No affiliates allowed (All viewing from publisher or the CMP Service's web site.)

If the amount to be divided from the compensation pool for this subscription and combination of entities is $0.10 for the day, and all three entities are present for this usage, then the content provider gets $0.07; the primary editor gets $0.02; the senior editor gets $0.01.

In the next example, assume that affiliates are supported, which is the usual, and the channel has the following parameters:

Content provider gets 66%

Primary editor gets 8%

Senior editor gets 6%

Affiliate that causes viewing gets 20%

If the amount to be divided from the compensation pool is $0.10 for the day, and all four entities are associated with this usage, then the content provider gets $0.066 for that day; the primary editor gets $0.008 for that day; the senior editor gets $0.006 for that day, and the affiliate that caused the viewing gets $0.02 for that day.

In both examples above, the TotalPercent is 100% and the TotalAmountAvailable (i.e. to be divided) is $0.10. Because all entities are present, including the affiliate, the calculation for each entity involved is simply:

EntityUsageAmount=TotalAmountAvailable*EntityPercentShare/TotalPercent.

Affiliates get special treatment for these calculations. They get exactly 20%, or some other stated percentage, of the compensation pool amount, typically not more or less, regardless of what other entities are involved.

Now, suppose that viewing took place without an affiliate referral. That is, the viewing was initiated from the publisher's own web site without any help from any affiliate web sites. (For all channels, any viewing directly initiated on the CMP Service web site, e.g. from a Google search, is considered to have no affiliate, and so the affiliate's share is divided among the remaining entities.)

When there's no affiliate, there's a lower TotalPercent to be divided up, in this case 66%+8%+6%=80%. So, now the amount of the $0.10 TotalAmountAvailable that the content provider would get is larger. It equals the $0.10*(66%/80%)=$0.0825. The amount that the primary editor would get is $0.10*(8%/80%)=$0.01. The senior editor would get $0.10*(6%/80%)=$0.0075.

The formula becomes a somewhat more complex when the affiliate is present, but one of the editors is missing. For example, assume that there is no senior editor for this particular content item. In that case, there is a lower TotalPercent. TotalAmountAvailable is still $0.10. The affiliate still gets $0.02, i.e. 20% of $0.10. The affiliate does not get extra, because the formulas are optimized to motivate the content providers. If less editing is required, the content provider wins. So the formula when there is an affiliate but one of the other entities is missing is adjusted to the following:

EntityUsageAmount=(TotalAmountAvailable−AffiliateAmount)*(EntityPercentShare/(TotalPercent−AffiliatePercent))

Since only the content provider and primary editor (besides the affiliate) are present in this example, only their percentages are considered to arrive at TotalPercent, which is 66%+8%=74%. So, now the amount the content provider would get equals ($0.10−$0.02)*(66%/74%)=$0.07135. The amount that the primary editor would get is ($0.10−$0.02)*(8%/% 74)=$0.008649.

After calculating the EntityContentItmUsageAmount for each of the EntityContentItmUsageTmp records, as illustrated above, the records are added to the database and committed, one record at a time.

Additionally, RollUpEntityContentItmUsageTmp is a batch processing service (job) used in closing of the day's accounting. The job rolls up the amounts in the EntityContentItmUsageTmp records for subscription usage payments to the channel's content providers, editors, and web site affiliates into the EntityContentItmUsage records for the day, most of which exist but show zero dollars for UsageAmount until this function runs. The job creates any EntityContentItmUsage records needed that do not exist, because there were no ContentClickEvents for them for that day, but there's an EntityContentItmUsageAmount that needs to be credited.

The EntityContentItmUsageTmp table is cleared of all records on a daily basis, i.e. at the start of the accounting period, and it is an optimization that avoids the need for costly sorts in the final rollup of EntityContentItmUsage records and allows for efficient addition of any EntityContentItmUsage records not already created prior to closing the day's accounting.

The Roll Up Entity Content Item Usage Temporary batch service converts EntityContentItmUsageTmp to EntityContentItmUsage records. All EntityContentItm-UsageTmp records (which all have the same ClickDate) are grouped by publication, entity, and payment transaction type. An EntityContentItmUsage record for each group is created, if necessary, and updated with an EntityContentItmUsageAmount.

Account closing is done one ActiveClickDate (processing date) at a time, and the RollUpEntityContentItmUsageTmp batch job in an intermediate step in the closing process for the previous day. It loops through all the EntityContentItmUsageTmp records, which are all for this accounting period (ActiveClickDate) and updates EntityContentItmUsage records, which accumulate the compensation pool payments (EntityContentItmUsageAmount) for the day.

Ideally, the Roll Up Entity Content Item Usage Temporary job runs once per day, after midnight (close) of ClickDate (“ActiveClickDate” for account processing). It can start immediately after the Collect Entity Content Item Usage Amount batch job for the day (yesterday) has completed. The job is run for typically only one ActiveClickDate at a time, which is the day following the LastEndActiveClickDate supplied in the Batch Parameter String. At the start of this job, the LastEndActiveClickDate parameter, if any, is read and incremented in memory to the next calendar day, to become the Current ActiveClickDate for this job. If NO LastEndActiveClickDate parameter is present, then the minimum ClickDate of all of the EntityContentItmUsage records minus one day is used as the LastEndActiveClickDate. This simplifies repeated runs against canned test data. If the CurActiveClickDate is more recent then yesterday, then RollUpEntityContentItmUsage returns a Batch Completion Code of COMPLET_ActiveClickDateTooRecent.

The reader thread executes a GROUP BY statement on the EntityContentItmUsageTmp records to sum up the EntityContentItmUsageAmount grouped by unique combinations of publication, entity, Payment Transaction Type, and ContentURL Remark Parameter. The main reader loop runs through the results and hands rows out to the writer threads.

The writer threads update the corresponding EntityContentItmUsage records with the EntityContentItmUsageAmount for the group. If no EntityContentItmUsage record exists, the writer creates it, including the calculated EntityContentItmUsageAmount, but all other usage fields are zero (because there was no actual usage for the day, just money credited for previous usage). (As the number of subscribers increase, there will be fewer and fewer EntityContentItmUsage records that need to be created this way.)

The method for determining that an EntityContentItmUsage record is missing for today is to always query for a record that has the current ClickDate or any lesser ClickDate. If a record for today is found then the EntityContentItmUsageAmount can be updated. If the most recent record found has yesterday's click date, which is typically the only other possibility, then a new record must be created, and it is given today's EntityContentItmUsageAmount.

Before doing this processing, the reader thread checks the ClickDate of the first EntityContentItmUsageTmp record to ensure that the date is the same as the current ActiveClickDate being processed. If the dates are different, RollUpEntityContentItmUsageTmp returns Batch Completion Codes of either COMPLET_InputRecClick-DateTooRecent or COMPLET_InputRecClickDateTooOld (i.e. comparing the EntityContentItmUsageTmp record's ClickDate to the Current ActiveClickDate). (Note, for example, that if this check were not made and the operator accidentally were to run this job too soon, the corresponding EntityContentItmUsage records might not yet exist, and RollUpEntityContentItmUsageTmp expects those records to be there.)

RollUpEntityContentItmUsageTmp is a multithreaded job that is assumed to run on a single batch machine. There is one reader thread for grouping the EntityContentItmUsageTmp records and multiple writer threads for creating or updating the EntityContentItmUsage records with the EntityContentItmUsageAmount. The writers combine the day's subscription-based EntityContentItmUsageTmp compensation pool amounts into the EntityContentItmUsageAmount field of the EntityContentItmUsage records, many of which already exist. The changes to records can be committed as the processing goes along, because recovery just involves resetting the Amount field to zero. Updates are made to non-indexed fields in records that are being touched by typically only one thread at a time, so the constant updating should not cause a performance bottleneck.

Additionally, RollUpEntityContentItmUsage is the batch processing service (job) that completes the closing of the day's accounting by rolling up the amounts in the EntityContentItmUsage records for usage payments to the channel's content providers, editors, and web site affiliates into EntityPaymentDetail records for the day.

The Roll Up Entity Content Item Usage batch service converts EntityContentItmUsage to EntityPaymentDetail records (to compensate for usage, i.e. this goes to Accounts Payable). This service groups all EntityContentItmUsage records for a given ClickDate by publication, entity, and payment transaction type and adds an EntityPaymentDetail record for each group. This function typically must run after RollUpEntityContentItmUsageTmp has finished processing the ActiveClickDate. For cleaning up after a crash, four types of data should be removed for the day—paid usage to content provider, primary editor, senior editor, or affiliate should be removed for this day. However, other payment transaction types are not removed.

Account closing is done one ActiveClickDate (processing date) at a time, and the RollUpEntityContentItmUsage batch job ends the closing process for the previous day. It loops through EntityContentItmUsage records that are relevant for this accounting period (ActiveClickDate) and creates EntityPaymentDetail records, which accumulate compensation pool payments (EntityUsageAmount) for the associated content items.

Ideally, the RollUpEntityContentItmUsage job runs once per day, after midnight (close) of ClickDate (“ActiveClickDate” for account processing). It can start immediately after the Roll Up Entity Content Item Usage Temporary batch job for the day (yesterday) has completed. The job is run for typically only one ActiveClickDate at a time, which is the day following the LastEndActiveClickDate supplied in the Batch Parameter String. At the start of this job, the LastEndActiveClickDate parameter, if any, is read and incremented in memory to the next calendar day, to become the Current ActiveClickDate for this job. If no LastEndActiveClickDate parameter is present, then the minimum ClickDate of all of the EntityContentItmUsage records minus one day is used as the LastEndActiveClickDate. This simplifies repeated runs against canned test data. If the CurActiveClickDate is more recent then yesterday, then RollUpEntityContentItmUsage returns a Batch Completion Code of COMPLET_ActiveClickDateTooRecent.

The main reader loop runs through the EntityContentItmUsage records for the Current ActiveClickDate, grouping them by publication, entity, and payment transaction type, and the writers create the EntityPaymentDetail records for that group by collecting the sum of the EntityContentItmUsageAmounts into the EntityUsageAmount for the group. (If operator accidentally runs this job too soon, zero records will be added, but the BatParamStr will have an incorrect LastEndActiveClickDate, which can be corrected by hand. If this batch job is accidentally skipped for a day, then there's no problem running it an extra time on a subsequent day.)

RollUpEntityContentItmUsage is a multithreaded job that is assumed to run on a single batch machine. There is one reader thread for grouping the EntityContentItmUsage records and multiple writer threads for creating the EntityPaymentDetail records. The addition of EntityPaymentDetail records for the usage data is done as separate transactions, and recovery deletes these records (instead of zeroing the usage amount fields).

The Accounting Reports Facility makes it easy for content providers, affiliates, editors, and publishers to track subscriber usage and payments due. In addition, those entities can make use of straightforward, independent audit methods to verify that usage tracking and division of the compensation pool are being done correctly.

The service keeps track of subscriber usage of the content items in a publication channel. The Accounting Reports Facility provides detailed intra-day usage reports within a few minutes of use. The report format allows associated content providers and affiliates to randomly test that the subscription usage is being accurately recorded without requiring information about any other subscriptions. Also, any payments due an entity at the time a subscription is sold appear within a few minutes of the sale.

Compensation pool accounting for content providers, affiliates, and editors takes place once per day, so most dollar amount fields will appear as blanks for today. The content usage appears in real time, but the dollar values for that usage do not appear until the next day in the accounting reports.

Each channel has an independent compensation formula that is uniformly applied to all subscriber usage within that channel. An individual subscription's contribution to the compensation pool is fully distributed by the end of the subscription. Entities are paid using formulas that distribute money in such a way as to reflect relative usage of the hosted material over the life of the subscription. This model makes it possible to be transparent, prevent gaming of the system, and appear fair to all parties involved.

The Accounting Report Facility depends on the batch services to put data into a format that can be manipulated easily and quickly by users. Reports are generated from these types of database entries (which have been created by the batch service processing of the content clicks and the subscription purchases):
1. data entries corresponding to each usage by a user, which can be examined by an associated content provider and affiliate without revealing usage not associated with that subscription;
2. data entries that aggregate subscriber usage by content item and affiliate, for examination by an associated content provider and affiliate without revealing aggregated usage not associated with that entity;
3. data entries that calculate the daily compensation pool money distributions in a format that allows associated content providers and affiliates to randomly test that the calculations are being done correctly for a given subscription and day, without requiring information about any other subscriptions.

Content providers, affiliates, editors, and publishers use the “Page Select Accounting Report” (pagSelAccountingRpt) to choose a publication, entity, and one of the first three reports: EntityPaymentDaily, EntityContentItmUsage, or ContentClick report.

The Entity Payment Daily Report (pagShowEntityPaymentDailyLst) lists payments due an entity for a publication, broken down by day and payment transaction type.

The user can typically get to the top-level report only from pagSelAccountingRpt. This report drills down on each row, leading to pagShowEntityContentItmUsageLst.

The Entity Content Item Usage Report (pagShowEntityContentItmUsageLst) lists usage and new subscription statistics for a publication and entity, broken down by day, content item, ContentURL Remark Parameter, and payment transaction type.

The user can get to this report from pagSelAccountingRpt or drill down from pagShowEntityPaymentDailyLst. Drilling down on each row leads to pagShowContent-ClickLst.

The Content Click Report (pagShowContentClickLst) lists the Content Click Events by subscribers to a given publication, for events that involve the selected entity in some role. The user can get to this report from pagSelAccountingRpt or drill down from pagShowEntity-ContentItmUsageLst. Drilling down on each row leads to pagShowContentClickAnd-SubscriptionDetail.

The Content Click and Subscription Detail Report (pagShowContentClick-AndSubscriptionDetail) displays the full detail of a single ContentClickEvent, along with the summary information about the subscription, including usage so far, the price paid for this subscription, and the original affiliate that sold the subscription, if any.

The user can get to this report by drilling down from pagShowContent-ClickLst, so the user sees this level of detail for ContentClickEvents that involve the specified entity. Drilling down from this report leads to ShowSubscriptionContentItmUsageLst.

The Subscription Content Item Usage Report (pagShowSubscriptionContent-ItmUsageLst) lists the accumulated historical paid usage out of the compensation pool of each content item for the specified subscription, along with the payment amount to the specified entity for those accesses involving the entity. The user can get to this report from a link on pagShowContentClickAndSubscriptionDetail.

From the Page Select Accounting Report Page, the user can select various accounting reports (pagSelAccountingRpt). These reports may include the Entity Payment Daily Report, which lists payments due an entity for a publication, broken down by day and payment transaction type; the Entity Content Item Usage Report, which lists usage and new subscription statistics for a publication and entity, broken down by day, content item, URL Remark Parameter, and payment transaction type; the Content Click Report, which lists the Content Click Events by subscribers to a given publication, for events that involve the selected entity in some role. There is one row per click by a subscriber on a URL.

The user selects a single publication and an entity (with both required) and then selects a report.

The Page Show Entity Payment Daily List lists payments due an entity for a given publication, broken down by day and payment transaction type. Commissions on subscription sales appear quickly. (Usage payments from the compensation pool do not appear until the next day.)

This report has StartDate and EndDate range and fixed publication and entity. The report begins with StartDate of yesterday and EndDate of today and therefore summarizes usage dollars up to the previous day.

Typically, at the top of this report (before the grid), the total payment amount is given for the specified date range and Payment Transaction Type(s). The TotalPaymentAmount is calculated first, and then the first page of the list is looked up and displayed. This Total row (at the top of detail table) has sum of all the rows in the full result set (NOT just currently displayed page).

The grid typically has one row per EntityPaymentDetail record, which applies to a single day's aggregated statistics and includes the payment amount. The grid columns are typically the date, payment transaction type and amount. Drilling down on each row leads to pagShowEntityContentItmUsageLst for publication, entity, click date.

The Entity Content Item Usage Report (pagShowEntityContentItmUsageLst) lists usage and new subscription statistics for a publication and entity, broken down by day, content item, ContentURL Remark Parameter, and payment transaction type. (Usage payment amounts appear once the day's accounting has closed.)

This report has a StartDate and EndDate range and fixed publication and entity. The ClickDate is passed by drill-down or takes a default value from pagSelAccountingRpt. This report begins with StartDate of yesterday if user launched or passed date if drill-down, and goes to EndDate of today if user launched or passed date if drill-down. This report summarizes usage dollars up to the previous day.

At the top of this report (before the grid), the total payment amount is given for the specified date range and Payment Transaction Type(s). The TotalPaymentAmount is calculated first, and then the first page of the list is looked up and displayed. This Total row (at top of detail table) has sum of all the rows in the full result set (not just the currently visible page). The grid has one row per EntityContentItmUsage record, which applies to a single day's aggregated statistics and includes the payment amount.

The Entity Content Item Usage Report shows ContentClicks registering quickly, immediately useful even without dollar amounts, and it further includes a money amount from the compensation pool for usage once the day's accounting has been closed. This report shows usage dollars up to yesterday, which can be earned with or without new content clicks but does not show dollar amounts for subscription sales. This report typically shows only dollar amounts for compensation pool usage. This report also shows how many new content clicks for the day and Content ID led to subscription sales.

The Content Click Report (pagShowContentClickLst) lists the Content Click Events by subscribers to a given publication, for events that involve the selected entity in some role. There is one row per click on a ContentURL. (For streaming, actual clicks are combined if they can be considered as a single “logical” content click event.) This report has a StartDate and EndDate range and fixed publication and entity. The report begins with StartDate of the previous day if user launched or passed date if drill-down, and goes to EndDate of today if user launched or passed date if drill-down.

The Content Click and Subscription Detail Report displays the full detail of a single ContentClickEvent, along with the summary information about the subscription, including usage so far, the price paid for this subscription, and the original affiliate that sold the subscription, if any.

Users who work for an entity can access usage info for subscribers that have interacted with the entity's content or web site. A content provider, editor, affiliate, or publisher can typically view only Content Click Events and Member Purchase Detail information when a subscriber accesses content that they are associated with. This is a low-level protection against revealing excessive subscriber information or content usage information belonging to the publisher. Drilling down from this report leads to ShowSubscriptionContentItmUsageLst.

The Subscription Content Item Usage Report (pagShowSubscriptionContent-ItmUsageLst) lists the accumulated historical paid usage out of the compensation pool of each content item for the specified subscription, along with the payment amount to the specified entity for those accesses involving the entity. Used for auditing and analysis of subscriber interest.

The SubscriptionContentItmUsageLst describes how a single subscription's compensation pool has been divided up and the amounts credited to this entity for this subscription up to this point in time. This report can be used for test audit cases to prove that no clicks are being lost and that the compensation pool calculation is being done correctly. In addition, this report can give insight into the interests of the audience, which is invaluable for improving the kind and quality of content.

The Subscription Content Item Usage Report includes calculations as how much compensation goes to the particular entity in question for each Subscription Content Item Usage record that involves that entity. This is based on the percentages set in the Publication Master.

Once a subscriber has accessed an entity's content or web site, that entity has the “right” to see at least a portion of the SubscriptionContentItmUsage records for that subscriber. This is desired for auditing whether or not entity payments are being tracked and calculated correctly, which is possible if the entity runs controlled experiments in which random subscriptions are purchased by the entity and an exact record of subscriber access is kept.

For a further degree of auditability, the service may not restrict an entity, for example a content provider, to viewing accesses made to his own material only, and to viewing only summaries of the rest of the accesses by the subscriber. This may be insufficient information to easily determine that the usage has been recorded accurately and that the compensation pool division has been calculated correctly.

Some, but not all, detail about the other usage of this subscription may be needed for rigorous verifiability. To check that the calculation of the content provider's share of the compensation pool is correct to the penny, the auditor would need the summary numbers for the other content providers and other affiliate web sites accessed by this subscription. For example, there is buffering of video that takes place that can cause a difference between the metering results for viewing time that the CMP Service records versus the use of a stopwatch by the auditor doing the testing. If the auditor knows exactly what has been accessed by the test subscriber and for how long, then he'll have no problem correlating what the Subscription Content Item Usage report shows with what the tester had done.

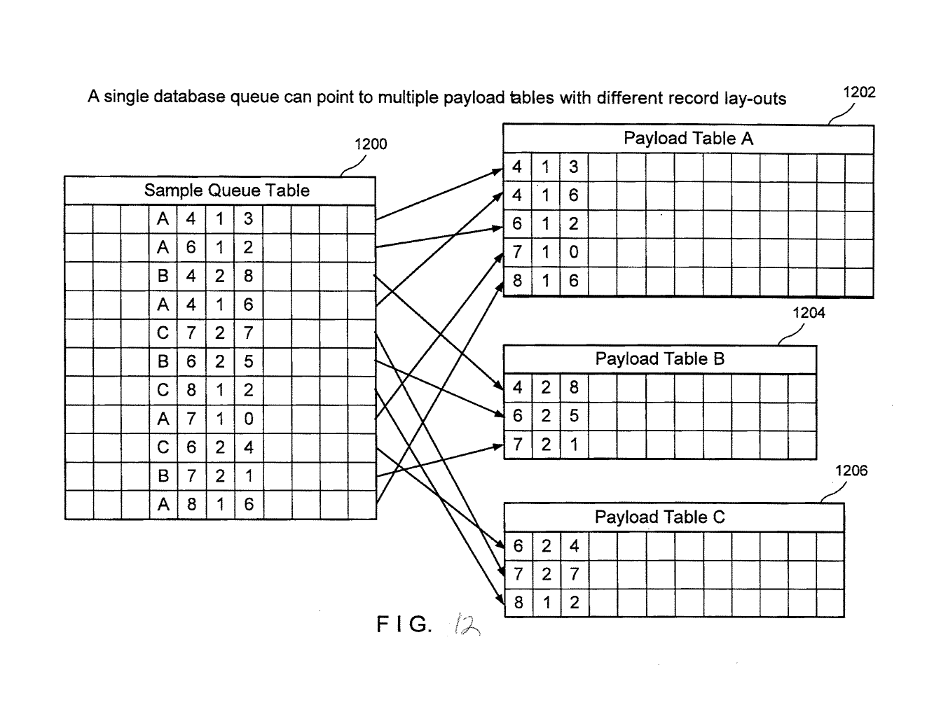

FIGS. 12-15 illustrate a typical example of a general purpose queuing mechanism which may be implemented in embodiments of the present disclosure. CMP's ContentClickQ table is an instance of the primary queue table shown as “Sample Queue Table” 1200, and ContentClickln is an instance of a “Payload” table (e.g. 1202) in FIG. 12.

For instance, FIG. 12 illustrates a single database queue 1200 with data or index entries pointing to multiple payload tables 1202, 1204, 1206 with different record layouts (i.e., record formats, which may include differences in length) by using a flag A, B or C which points to payload tables 1202, 1204, 1206, respectively.

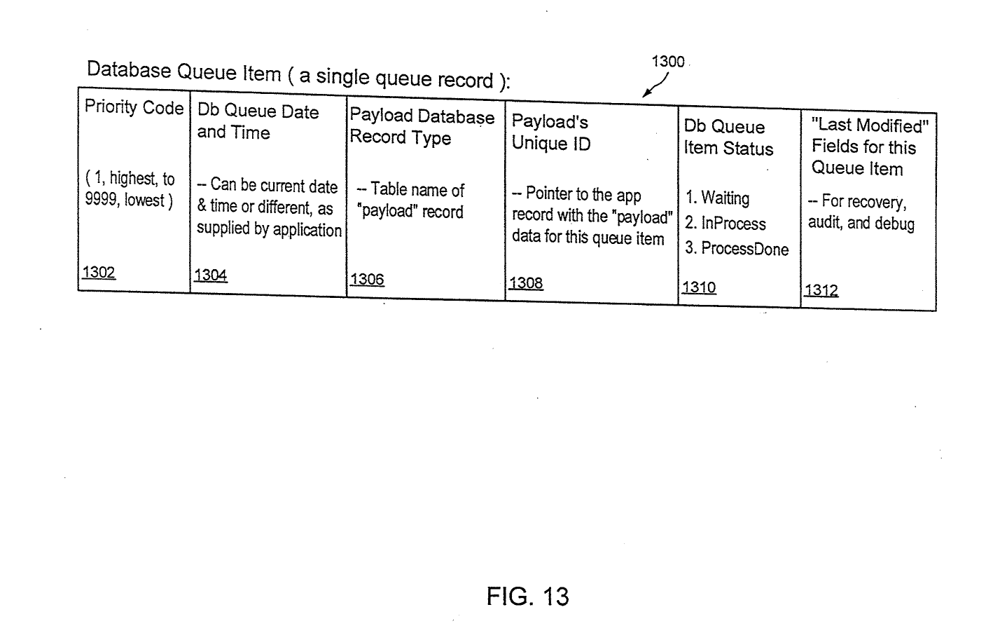

FIG. 13 illustrates a typical instruction lay-out 1300 within the distributed processing queue. A typical instruction lay-out includes priority 1302, date/time scheduled 1304, payload type 1306, payload identification 1308, status 1310 (typically waiting, in process or done) and information (typically user date and time, used for recovery and audit) regarding last modification 1312. Typically, such queues include a single, unique index, and keys (index entries) do not change position or move within the index as status changes. This helps to minimize contention due index locking, enhancing performance under heavy concurrent usage.

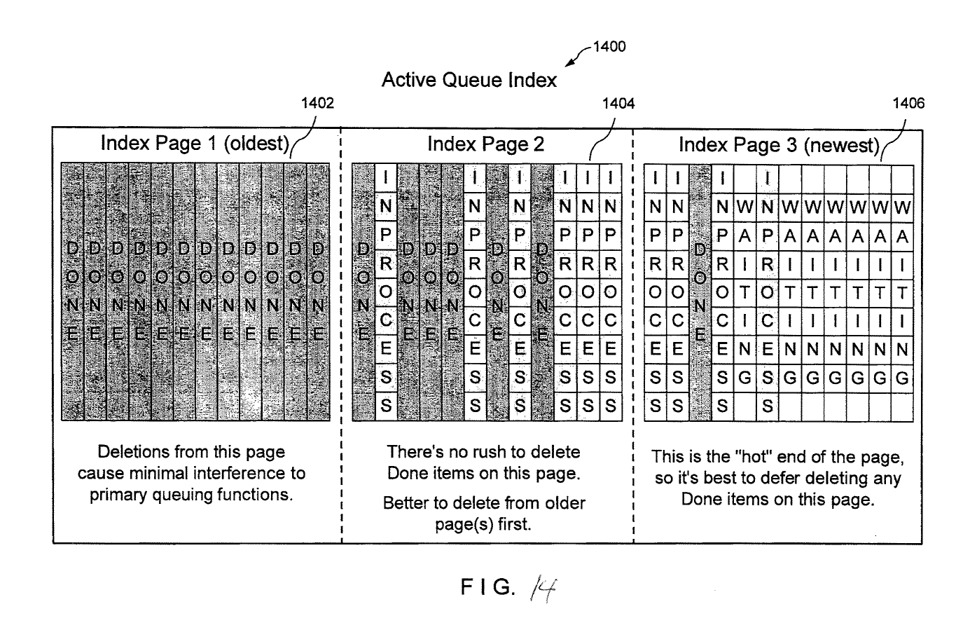

FIG. 14 illustrates an active queue's index 1400 with delayed deletions of entries. While FIG. 14 is illustrated with three index pages, first page 1402 (the oldest), second page 1404 (intermediate in age) and third page 1406 (the newest), it is envisioned that typically more than three pages employ this configuration. Deletions from the oldest index page 1402 cause minimal interference to the primary queuing functions. Deletions from the intermediate page 1404 are not urgent and it is typically preferred to make deletions from the oldest index page 1402. Similarly, it is preferable to defer making deletions from the newest index page 1406.

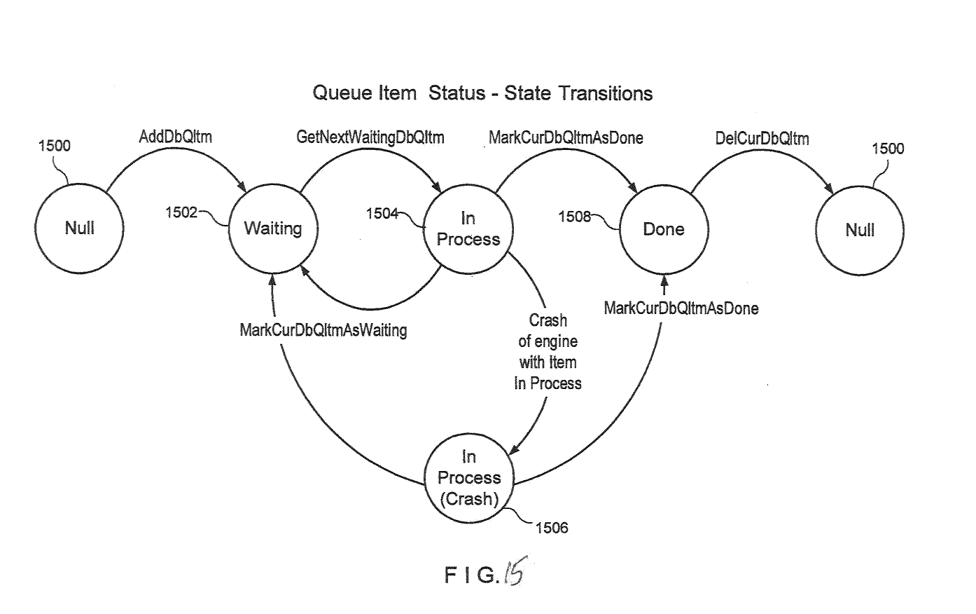

FIG. 15 illustrates the state transition of the database queue item status. The null state 1500 (illustrated for simplicity twice on FIG. 15) can transition to the waiting state 1502. The waiting state 1502 can transition to the in-process state 1504. The in-process state can have any of three outcomes—transition back to waiting state 1502, transition to crashed (e.g. failure) in process state 1506 or the done state 1508. The done state 1508 can thereafter transition to the null state 1500.

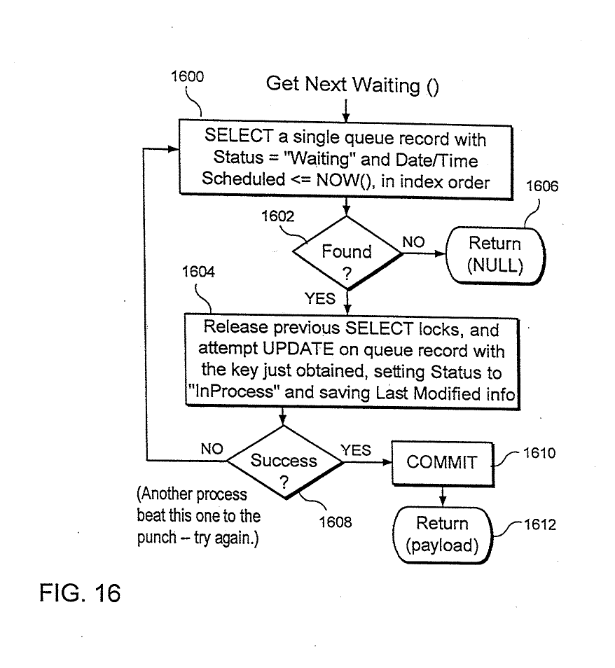

FIG. 16 illustrates the flow diagram of a high speed queuing operation, applicable to an embodiment of the system 10 of the present disclosure. In block 1600, a single queue record or task is selected. If this queue record is found, as determined by decision block 1602, then in block 1604, the previous select locks are released and an update on the queue record with the key obtained is attempted, changing the status to “in process” (see state 1504 in FIG. 15) and saving the information regarding last modification (see column 1312 in FIG. 13). If this queue record is not found, as determined by decision block 1602, then the request is returned as null in block 1606.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

### APPENDIX

### Glossary

affiliate: the owner or proprietor of a web site that embeds links to one or more items of content in a CMP publication channel, in exchange for compensation in connection with subscription sales and/or subscriber usage attributable to those links. The affiliate has a unique identifier, which is included in the URLs of his or her links in order to make this association known to the CMP Service.
batch processing: a non-interactive mode of processing that typically entails the use of a queue of work or batch jobs, which can be performed by a distributed network of application servers in communication with a shared database. A batch job may execute as a single, recoverable database transaction, or it may execute a series of transactional steps, in which case a “cleanup” procedure may be required for recovery from unexpected failures or crashes. Batch jobs often support modes of parallel execution or multi-threading, which can be important to an application's performance and scalability.
content click event: a unit of usage of a single content item through a particular content URL, which forms the basis for all of the CMP Service's accounting and reporting functions. A single content click event may represent an aggregation of some number of consecutive intervals of streaming activity.
content item: a discrete unit of proprietary digital material in a CMP publication channel, typically having an associated content provider and a primary editor, who automatically receive compensation from the CMP Service on the basis of authenticated subscriber usage. (Affiliates also may receive a share of compensation for subscriber usage of content items to which they refer subscribers.) Depending upon the type of channel, content items may be either downloadable files (e.g. documents, images, or software), or they may be streaming media such as music or video clips.
Content Marketplace Platform: abbreviated “CMP”, this is the subscription-based system and method of distributing digital content that is the subject of this disclosure. A CMP service provider, the CMP Service, supports any number of publication channels, providing functions for subscription processing, accounting, reporting and administrative functions. The CMP Service automatically handles compensation of content providers, editors, publishers, and affiliates according to a formulaic system whose aim is to be fair to all parties, verifiable, and resistant to abuse.
content provider: the owner, e.g. author, artist, or copyright holder, of one or more pieces of digital material licensed for distribution by the CMP Service, in exchange for compensation or credit based on subscriber usage.
content URL: a logical address designating a single content item within a specific CMP publication channel. The content URL typically may also include affiliate-related parameters to indicate the source of the referral.
editor: an individual who serves at the discretion of CMP channel publisher, and who is responsible for receiving material from one or more content providers, approving its inclusion, and incorporating it into a CMP publication channel. An editor may receive a salary from his or her publisher, and additionally may receive automated, usage-based compensation in connection with subscriber use of the items of content to which he or she has been assigned. Each item of content may be associated with a primary editor, and there may be senior editors who are responsible for one or more primary editors. A senior editor may receive a salary from his or her publisher, and additionally may receive automated, usage-based compensation in connection with subscriber use of the items of content to which his or her primary editors have been assigned.
entity: a person, business, or organization that fills one or more of the following roles: CMP Service, publisher, editor, content provider, affiliate, or subscriber (end user). Typically each content provider who owns a web site will also be an affiliate. The CMP Service also may act in the role of publisher for some channels. Other combinations of entity roles are possible, for example a content provider may also be an editor. CMP defines compensation formulas that apply to each entity role.
publication channel: or simply a “channel”, is password-protected CMP service for displaying or retrieving a collection of proprietary content items, which may originate from any number of independent content providers. Each channel belongs to a publisher and is managed by any number of editors, who work for the publisher. Channels are made available to the public separately on a paid subscription basis, for some stated subscription duration. Items of content within a channel are not sold individually, but collectively they are accessible to all subscribers to that channel. A portion of revenues from subscription sales is immediately paid to the publisher and the CMP Service, and another portion is reserved in a compensation pool for automated payment to content providers and editors on the basis of subscriber usage over the life of each subscription. Affiliates may receive either a portion of the subscription sale or a portion of the compensation pool, or both, based on their referrals to items of content.
publisher: the owner of one or more CMP publication channels and associated lists of subscribers. The publisher is an independent business entity who uses the CMP Service in exchange for an agreed-upon commission on sales of subscriptions to his or her channels. The publisher is responsible for hiring and supervising editors, marketing activities, and assigning various CMP Service parameters relating to subscription pricing, terms, and compensation formulas. Receipt of subscription revenues, accounting, and automated compensation, however, are handled by the CMP Service. A publisher typically would have its own, independent web site, which would be linked in a relatively seamless way to its corresponding CMP channel(s).
transaction: is a term that has two different, widely used meanings. A financial transaction is, for example, a single credit card purchase event, which might cover the purchase of subscriptions to several CMP channels at one time. A database transaction is a recoverable, “atomic” unit of work against a relational database, such as Oracle or Microsoft SQL Server. Typically a financial transaction would comprise one or more database transactions, for which there are standard, well-studied methods of guaranteeing rigorous consistency, reliability, and recovery from unusual errors and system crashes.

What is claimed is:

1. A method for supporting time-based subscription-based channels of on-line content, and delivering a stream of income and usage characteristics to multiple content providers and affiliates who provide the content and direct users to the content, comprising the steps of:
providing a database with hosted material for access by authenticated users;
delivering hosted material from the database to users based on associated links that include the channel name, a unique descriptive string identifying the content to deliver, and an affiliate identification;
monitoring and recording each authenticated usage of channel content;
providing usage reports in a format that allows associated content providers and affiliates to monitor that the subscription usage is being accurately recorded without requiring information about any other subscriptions;
allocating a first portion of the income stream at the time the subscription is purchased to a first plurality of parties and a compensation pool;
allocating the compensation pool amounts to a second plurality of parties based on predetermined formulas, wherein the allocation step has the characteristics of,
specifying a usage metric upon which the channel's compensation formula is based;
having a compensation formula that is uniformly applied to all subscriber usage within a given channel, such that an individual subscription's contribution to the compensation pool is fully distributed by the end of the subscription;
periodically apportioning the compensation pool into periodic distributions that are to be disbursed to content providers with respect to content which is accessed and to affiliates with respect to users who have been directed to the database;
apportioning the distributions of the compensation pool reflecting relative usage of the hosted material over the entire life of the subscriptions;
generating data entries corresponding to each usage by a user that can be examined by an associated content provider and affiliate without revealing usage not associated with that subscription;
generating data entries that aggregate subscriber usage by content item and affiliate for examination by an associated content provider and affiliate without revealing aggregated usage not associated with that entity;
periodically generating data entries that calculate the compensation pool money distributions in a format that allows associated content providers and affiliates to monitor that the calculations are being done correctly for a given subscription and day without requiring information about any other subscriptions.

2. The method of claim 1 wherein the associated links include a remark section for use by the corresponding affiliate.

3. The method of claim 2 wherein the remark is free-form.

4. The method of claim 2 wherein the data entries that aggregate subscriber usage include a remark string.

5. The method of claim 1 wherein the usage in the step of apportioning is with respect to unique downloads.

6. The method of claim 1 wherein the usage in the step of apportioning is with respect to extent of time of data streaming.

7. The method of claim 1 further including the step of compensating the first plurality of parties in accordance with the step of allocating a first portion of the income stream.

8. The method of claim 1 further including the step of compensation the second plurality of parties in accordance with the step of allocating the compensation pool amounts.

9. The method of claim 8 wherein the first plurality of parties includes affiliates.

10. The method of claim 9 wherein the first plurality of parties includes financial institutions.

11. The method of claim 10 wherein the first plurality of parties includes the proprietor of the method.

12. The method of claim 11 wherein the first plurality of parties includes publishers selecting material for the database.

13. The method of claim 11 wherein the second plurality of parties includes authors of the material for the transactions.

14. The method of claim 13 wherein the second plurality of parties includes editors of the material for the transactions.

15. The method of claim 14 wherein the second plurality of parties includes affiliates who host websites which direct users to the database.

16. The method of claim 1 wherein the step of providing usage reports allows for randomly testing that the subscription usage is being accurately recorded.

17. The method of claim 1 wherein the step of providing usage reports provides intra-day usage reports on an hourly basis.

18. A method for assessing the relative merit of a plurality of authors and editors contributing to a collective body of digital content, comprising the steps of:
establishing one or more online publications through the contributions of a plurality of authors and editors;
registering a plurality of users as subscribers to one or more of these publications;
monitoring and recording authenticated usage of the digital content by the users;
allocating non-monetary units of credit to a compensation pool associated with each online publication;
periodically apportioning each compensation pool into periodic allowances;
apportioning the periodic allowances into credits to individual contributors, corresponding to the relative usage received by authenticated users; and
allocating those credits to the total score of each of the authors and editors involved.

19. The method of claim 18 wherein the usage in the step of apportioning is with respect to unique downloads.

20. The method of claim 19 further including means for limiting a size of total downloads by an authenticated user.

21. The method of claim 18 wherein the usage in the step of apportioning is with respect to extent of time of data streaming.

22. The method of claim 21 further including means for limiting a total time of data streaming by an authenticated user.

23. The method of claim 18 wherein the step of monitoring and recording usage by authenticated users is done by a plurality of processors operating in parallel.

24. The method of claim 23 further including means for preventing multiple simultaneous log-ins by a single authenticated user.

25. A method for allocating an income stream derived from on-line subscriptions, comprising the steps of:
providing a database with a plurality of publications, received from content providers, each of the publications having a URL associated therewith, for access to the publication;
receiving an income stream in return for the on-line subscriptions;
monitoring and recording usage of the database by authenticated users;
allocating a first portion of the income stream to a first plurality of parties;
allocating a second portion of the income stream to a compensation pool;
generating data entries corresponding to each usage by a user that can be examined by an associated content provider and affiliate without revealing usage not associated with that subscription;
generating data entries that aggregate subscriber usage by content item and affiliate for examination by an associated content provider and affiliate without revealing aggregated usage not associated with that entity;
periodically generating data entries that calculate the compensation pool money distributions in a format that allows associated content providers and affiliates to randomly test that the calculations are being done correctly for a given subscription and day without requiring information about any other subscriptions.

26. The method of claim 25 wherein the step of determining an income stream includes a step of determining a duration of a subscription, wherein step of apportioning includes the step of calculating an average payment per usage, and wherein said step of allocating includes calculating a total payment for the given day.

27. The method of claim 26 wherein the first plurality of parties includes affiliates.

28. The method of claim 27 wherein the first plurality of parties includes financial institutions.

29. The method of claim 28 wherein the first plurality of parties includes the proprietor of the method.

30. The method of claim 29 wherein the first plurality of parties includes publishers providing material for the transactions.

31. The method of claim 30 wherein the second plurality of parties includes authors of the material for the transactions.

32. The method of claim 31 wherein the second plurality of parties includes editors of the material for the transactions.

33. The method of claim 32 wherein the second plurality of parties includes affiliates who host websites instrumental in the transactions.

34. A method for allocating an income stream derived from on-line subscriptions, comprising the steps of:
providing a database with a plurality of publications, received from content providers, each of the publications having a URL associated therewith, for access to the publication;
receiving an income stream from users in return for access to the plurality of publications in the database;
monitoring and recording usage by authenticated users, based accessing the URL associated with the publication;
allocating a first portion of the income stream to a first plurality of parties;
allocating a second portion of the income stream to a compensation pool;
in response to the accessing of the URLs associated with the publications, generating data entries corresponding to each usage by an authenticated user received in return for the on-line subscriptions, wherein the data entries are stored in a queue, wherein the queue contains a plurality of index entries in an index for ordering a corresponding plurality of tasks;
periodically generating data entries that calculate the compensation pool money distributions in a format that allows associated content providers and affiliates to monitor that the calculations are being done correctly.

35. The method of claim 34 wherein at least one of the first and second pluralities of parties includes affiliates who host websites for implementing referrals to the database, and wherein the method further includes the step of generating tracking data entries corresponding to an affiliate providing a user with access to a publication, wherein the URL further includes affiliate identification which implements the step of generating data entries corresponding to an affiliate providing a user with access to a publication.

36. The method of claim 35 wherein the URLs include a URL remark parameter, wherein the method further includes the step of tracking referrals to the database by use of the URL remark parameter.

37. The method of claim 36 wherein the URL further includes data relating to an internet address of the publication and a method of delivery of the publication.

38. The method of claim 34 further including the step of generating reports based on the data entries stored in the queue.

39. The method of claim 34 wherein the usage in the step of apportioning is with respect to unique downloads.

40. The method of claim 34 wherein the usage in the step of apportioning is with respect to extent of time of data streaming.

41. The method of claim 34 further including the step of compensating the first plurality of parties in accordance with the step of allocating a first portion of the income stream.

42. The method of claim 34 further including the step of compensation the second plurality of parties in accordance with the step of allocating the compensation pool amounts.

43. The method of claim 42 wherein the first plurality of parties includes financial institutions.

44. The method of claim 43 wherein the first plurality of parties includes the proprietor of the method.

45. The method of claim 44 wherein the first plurality of parties includes publishers providing material for the transactions.

46. The method of claim 45 wherein the second plurality of parties includes authors of the material for the transactions.

47. The method of claim 34 wherein the second plurality of parties includes editors of the material for the transactions.

48. A data processing system for allocating subscription revenue, comprising:
a database with hosted material for access by authenticated users, wherein the database can deliver hosted material to users based on associated links;
an interface for monitoring and recording each authenticated usage of channel content;
a calculational module which provides usage reports in a format that allows associated content providers and affiliates to monitor that the subscription usage is being accurately recorded without requiring information about any other subscriptions;
wherein the calculational module allocates a first portion of the income stream at the time the subscription is purchased to a first plurality of parties and a compensation pool and allocates the compensation pool amounts to a second plurality of parties based on predetermined formulas, wherein the predetermined formulas specify a usage metric upon which the channel's compensation formula is based and are applied to all subscriber usage within a given channel, such that an individual subscription's contribution to the compensation pool is fully distributed by the end of the subscription;
wherein the calculational module further periodically apportions the compensation pool into periodic distributions that are to be disbursed to content providers with respect to content which is accessed and to affiliates with respect to users who have been directed to the database; apportions the distributions of the compensation pool reflecting relative usage of the hosted material over the entire life of the subscriptions; generates data entries corresponding to each usage by a user that can be examined by an associated content provider and affiliate without revealing usage not associated with that subscription; generates data entries that aggregate subscriber usage by content item and affiliate for examination by an associated content provider and affiliate without revealing aggregated usage not associated with that entity; and periodically generates data entries that calculate the compensation pool money distributions in a format that allows associated content providers and affiliates to monitor that the calculations are being done correctly for a given subscription and day without requiring information about any other subscriptions.
